(19) United States
(12) Patent Application Publication
(10) Pub. No.: US 2025/0169478 A1
(43) Pub. Date: May 29, 2025

(54) AQUACULTURE ASSEMBLY FOR GENERATING COMPRESSED AIR AND CONCENTRATED OXYGEN, AND METHOD OF GENERATING THE SAME

(71) Applicant: Poseidon Ocean Systems Ltd., Campbell River (CA)

(72) Inventors: Evan LOGUE, Campbell River (CA); Mathew Stephen CLARKE, Campbell River (CA)

(73) Assignee: Poseidon Ocean Systems Ltd., Campbell River (CA)

(21) Appl. No.: 19/036,537

(22) Filed: Jan. 24, 2025

Related U.S. Application Data
(63) Continuation of application No. PCT/CA2023/050932, filed on Jul. 11, 2023.
(60) Provisional application No. 63/394,547, filed on Aug. 2, 2022.

(51) Int. Cl. A01K 63/04; B01D 45/16; B01D 46/00; B01D 53/047; B01D 53/26

(52) U.S. Cl. CPC A01K 63/042; B01D 45/16; B01D 46/003; B01D 53/047; B01D 53/261; B01D 2256/12; B01D 2257/102; B01D 2257/80; B01D 2258/06

(57) ABSTRACT

There is provided an aquaculture assembly for generating compressed air and concentrated oxygen. The assembly includes an aeration system. The assembly includes an oxygen concentrator. The assembly includes a compressor operatively connected to both the aeration system and the oxygen concentrator. The compressor selectively directs compressed air to the aeration system, the oxygen concentrator or both the aeration system and the oxygen concentrator. The assembly may include a variable speed engine directly coupled to the compressor. There is also provided oxygen generation system with a fluid-air heat exchanger configured to receive therethrough and cool compressed air. A filtration unit, downstream of the fluid-air exchanger, removes liquid from the compressed air so cooled. An oxygen concentrator, downstream of the filtration unit, includes one or more vessels via which the compressed air is selectively received. Each said vessel includes an adsorbent and a desiccant therewithin.

### BACKGROUND OF THE INVENTION

### Field of the Invention

There is provided an aquaculture assembly. In particular, there is provided an aquaculture assembly for generating compressed air and concentrated oxygen, as well as a method of generating the same.

### Description of the Related Art

Ocean-borne aquaculture globally is calling for increased attention towards farmed species welfare. This has culminated into two separate areas of in-water life-support: aeration and oxygenation.

Aeration consumes compressed air to create large movements of sea water. It does this by diffusing compressed air at depth, creating a vertical rising column of air bubbles. The air bubbles induce an upwelling of water, bringing water from depth towards the surface. This water from depth is considered favorable because it is cold and contains fewer microorganisms. This rising water can create a barrier effect at the surface, blocking movement of external surface water towards the marine cage. This can reduce the inflow of unfavourable microorganisms typically found in the first few meters of ocean depth.

Water oxygenation comprises adding/consuming/dissolving compressed oxygen within water to raise the dissolved oxygen (DO) level of sea water. This is typically achieved with in-pen diffusers or similar technologies. Increased DO levels can lead to stronger growth of farmed aquatic species (e.g. fish etc.) and can help mitigate low-oxygen events that can harm the farmed species.

Compressed air may be generated on-site by means of either diesel-powered or electric air compressors. Compressed oxygen may be either generated on-site or continuously brought in via one or bottles/cylinders thereof. On-site generation of oxygen involves separation of compressed air by means of a chemical process. Bottled oxygen may be generated off-site via cryogenic air separation, for example.

To obtain oxygen via a chemical process, currently in the art in aquaculture applications there may be provided a diesel generator which provides power for an electric generator. The electric generator provides electricity to an electric motor. The electric motor powers a rotary screw compressor. Ambient air may be compressed, for example to 125 psig. The electric motor/rotary screw compressor may represent a typical electric compressor major unit and may comprise the majority of the system's power consumption. The outlet stream may be directed to a refrigerated dryer arranged downstream of the screw compressor, where the air so compressed may be cooled, for example to approximately 7° C. This cooling causes the majority of the water vapor to condense, with the water so condensed being thereafter removed from the bulk air stream. Dried air resulting therefrom is directed to an air receiver where it may remain for a period of time.

Pressure swing adsorption (PSA) and vacuum swing adsorption (VSA) arrangements may be provided downstream of the refrigerator dryer. Pressure swing adsorption is a means to carry out oxygen concentration through air separation. This is done by passing compressed air through one or more adsorbent columns, which preferentially adsorbs the nitrogen over the oxygen out of the air. This adsorption may be performed by small beads, which have an extremely high interfacial area due to a complicated internal pore structure. Under pressure, the beads adsorb gas until they reach a point of saturation. This process may be reversible such that releasing the pressure causes the adsorbent beads to release the gas the beads are holding, thereby allowing the beads to be “regenerated” for subsequent uses. The final oxygen product downstream of the adsorbent columns may delivered at a reduced pressure from input, such as for example at approximately 80 psig. This oxygen may be collected in an oxygen receiver, with the oxygen ultimately consumed by the oxygen system.

Japanese Patent Application Publication No. JP1994007056 to Katsuzo discloses a large screw blower driven by a diesel engine. A larger amount of standard compressed air is discharged from a main air tube and is guided to a culture net. An AC generator is connected to the diesel engine, and a small compressor is driven by the AC power generated by the AC generator to discharge a small amount of compressed air to a discharge tube. The compressed air is then directed to an air dryer to remove moisture. The dried compressed air exiting the air dryer is passed through a connecting tube to a PSA where the nitrogen is separated into a high concentration of oxygen-containing air. Next, ozone is generated in the high concentration of oxygen introduced into the ozone generator through the connection tube.

Japanese Patent Reference No. JPH0556730A to Katsuzo discloses an apparatus for supplying ozone and air to a fish preserve effective for preventing the occurrence of disease of culture fish and lowering the death rate of the fish by increasing the dissolved oxygen concentration in seawater and sterilizing sundry germs. The apparatus is mounted on a barge composed of a generator, a blower, a diesel engine to drive the generator and the blower, an ozone-generator to generate ozone by the electric power of the generator 07 and an ozone-supplying pipe to introduce the exhaust gas of the blower into the ozone-generator and introduce a mixture of ozone and air into a fish preserve.

### BRIEF SUMMARY OF INVENTION

There is provided, and it is an object to provide, an improved aquaculture assembly disclosed herein which selectively generates compressed air, concentrated oxygen or both.

There is a provided an aquaculture assembly or a unified system according to one aspect. The system includes a means to co-generate compressed air and concentrated oxygen continuously and on-demand modify the split ratio between the air and oxygen.

There is accordingly provided an aquaculture assembly according to another aspect. The aquaculture assembly includes a compressor via which compressed air is output. The aquaculture assembly includes one or more valves, the actuation of which enables said compressed air to be selectively directed to one or more of an aeration system or an oxygen concentrator.

There is also provided an aquaculture assembly according to a further aspect. The aquaculture assembly includes a variable speed engine. The aquaculture assembly includes a compressor directly coupled to and powered by the engine. The compressor outputs compressed air via an outlet thereof.

There is further provided an aquaculture assembly according to an additional aspect. The aquaculture assembly includes an aeration system. The aquaculture assembly includes an oxygen concentrator. The aquaculture assembly includes a compressor operatively connected to both the aeration system and the oxygen concentrator. The aquaculture assembly includes one or more valves via which compressed air from the compressor is directed to the aeration system, the oxygen concentrator or both the aeration system and the oxygen concentrator.

There is also provided an aquaculture assembly according to another aspect. The aquaculture assembly includes a compressor for generating compressed air. The aquaculture assembly includes an aeration system to which a set portion of the compressed air is directed. The aquaculture assembly includes an oxygen concentrator to which an excess portion of the compressed air is diverted to generate concentrated oxygen therefrom.

There is additionally provided an aquaculture assembly according to a further aspect. The aquaculture assembly includes an engine-driven, low-volume ratio, oil-injected compressor to generate compressed air. A set portion of the compressed air is directed to the aeration system. An excess portion of the compressed air is directed to an oxygen concentrator, with concentrated oxygen being generated from the compressed air diverted to the oxygen concentrator.

There is further provided an aquaculture assembly according to another aspect. The aquaculture assembly includes a compressor. The aquaculture assembly includes an aeration system operatively connected to the compressor so as to selectively receive compressed air therefrom. The aquaculture assembly includes an oxygen concentrator operatively connected to the compressor so as to selectively receive compressed air therefrom. The outlet of the oxygen concentrator is different than and/or distinct from the outlet of the aeration system.

There is also provided an aquaculture assembly according an additional aspect. The aquaculture assembly includes an aeration system for receiving compressed air. The aquaculture assembly includes a minimum pressure valve operatively connected to the aeration system and which actuates in response to an excess portion of compressed air not being consumed by the aeration system. The minimum pressure valve so actuated directs said excess portion of compressed air to an oxygen concentrator.

There is further provided an aquaculture assembly according to yet an additional aspect. The aquaculture assembly includes an aeration system for receiving compressed air. The aquaculture assembly includes a minimum pressure valve operatively connected to the aeration system. The minimum pressure valve is configured to actuate upon being subjected to a pressure equal to or greater than a predetermined threshold of pressure indicative an excess portion of compressed air not being consumed by the aeration system. The minimum pressure valve so actuated is configured to direct said excess portion of compressed air to an oxygen concentrator.

There is additionally provided an aquaculture assembly according to another aspect. The aquaculture assembly includes a compressor. The aquaculture assembly includes an aeration system operatively connected to the compressor so as to selectively receive compressed air therefrom. The aquaculture assembly includes an oxygen concentrator operatively connected to the compressor so as to selectively receive compressed air therefrom. The aquaculture assembly includes air treatment components common to both the aeration system and the oxygen concentrator.

There is also provided an oxygen generation system for aquaculture according to one aspect. The oxygen generation system includes a fluid-air heat exchanger to receive therethrough and cool compressed air and/or condense out water and/or oil vapor therefrom. The oxygen generation system includes a filtration unit downstream of the fluid-air exchanger. The filtration unit removes liquid such as humidity/water and/or oil, from the compressed air so cooled. The oxygen generation system includes a desiccant downstream of the filtration unit.

There is yet further provided an oxygen generation system for aquaculture according to another aspect. The oxygen generation system includes a fluid-air heat exchanger to receive therethrough and cool compressed air and/or condense out water and/or oil vapor therefrom. The oxygen generation system includes a filtration unit downstream of the fluid-air exchanger. The filtration unit removes liquid such as humidity/water and/or oil, from the compressed air so cooled. The oxygen generation system includes an oxygen concentrator downstream of the filtration unit. The oxygen concentrator includes one or more vessels via which the compressed air is selectively received. Each said vessel includes an adsorbent and a desiccant therewithin.

There is further provided a method of generating concentrated oxygen and compressed air for aquaculture according to one aspect. The method includes directly coupling a prime mover to a compressor so as to output compressed air. The method includes selectively directing a first portion of the compressed air to an oxygen concentrator. The method includes selectively directing a second portion of the compressed air to an aeration system.

There is also provided a method of generating compressed air for aquaculture assembly according to another aspect. The method includes providing motive power via a variable speed engine. The method includes powering a compressor via the variable speed engine. The method includes outputting compressed air via the compressor.

There is additionally provided a method of generating oxygen for aquaculture according to a further aspect. The method includes directing compressed air through a liquid-air heat exchanger so as to cool the compressed air and/or condense out water and/or oil vapor therefrom. The method includes directing the compressed air so cooled through a filtration unit to further remove liquid therefrom. The method includes outputting oxygen via an oxygen concentrator downstream of the filtration unit. The method may include additionally dehumidifying the compressed air via a desiccant downstream of the filtration unit.

There is further provided a method of generating concentrated oxygen and compressed air for aquaculture according to yet another aspect. The method includes providing a compressor configured to output compressed air. The method includes providing one or more valves downstream of the compressor. The method includes operatively connecting an aeration system and an oxygen concentrator to the compressor via said one or more valves.

There is additionally provided a method of generating concentrated oxygen and compressed air for aquaculture according to a further aspect. The method includes providing an aeration system and an oxygen concentrator. The method includes operatively connecting together the aeration system and the oxygen concentrator via a single compressor upstream thereof.

There is also provided a method of generating concentrated oxygen and compressed air for aquaculture according to yet an additional aspect. The method includes providing a compressor configured to generate compressed air. The method includes directing a set portion of the compressed air to an aeration system. The method includes diverting an excess portion of the compressed air to an oxygen concentrator.

There is further provided a method of generating concentrated oxygen and compressed air for aquaculture according to another aspect. The method includes arranging an aeration system to receive compressed air from a single source. The method includes configuring an oxygen concentrator to selectively receive compressed air from the single source. The method includes arranging the outlet of the oxygen concentrator to be different than and/or distinct from the outlet of the aeration system.

There is yet also provided a method of generating concentrated oxygen and compressed air for aquaculture according to a further aspect. The method includes configuring an aeration system to receive compressed air. The method includes operatively connecting a minimum pressure valve to the aeration system. The method includes configuring the minimum pressure valve to actuate in response to an excess portion of compressed air not being consumed by the aeration system. The method includes directing the excess portion of compressed air to an oxygen concentrator in response to the minimum pressure valve so actuated.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is a schematic process flow diagram of an aquaculture assembly according to one aspect, the aquaculture assembly being for generating compressed air and concentrated oxygen, with an oxygen concentrator thereof not being shown;

FIG. 2 is a schematic process flow diagram of the oxygen concentrator of the aquaculture assembly thereof;

FIG. 3 is a schematic process flow diagram of an aquaculture assembly according to another aspect;

FIG. 4 is a schematic process flow diagram of the oxygen concentrator of the aquaculture assembly thereof; and

FIG. 5 is a table setting out volumetric flowrates and other operating parameters of the aquaculture assembly according to one illustrative and non-limiting example thereof.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

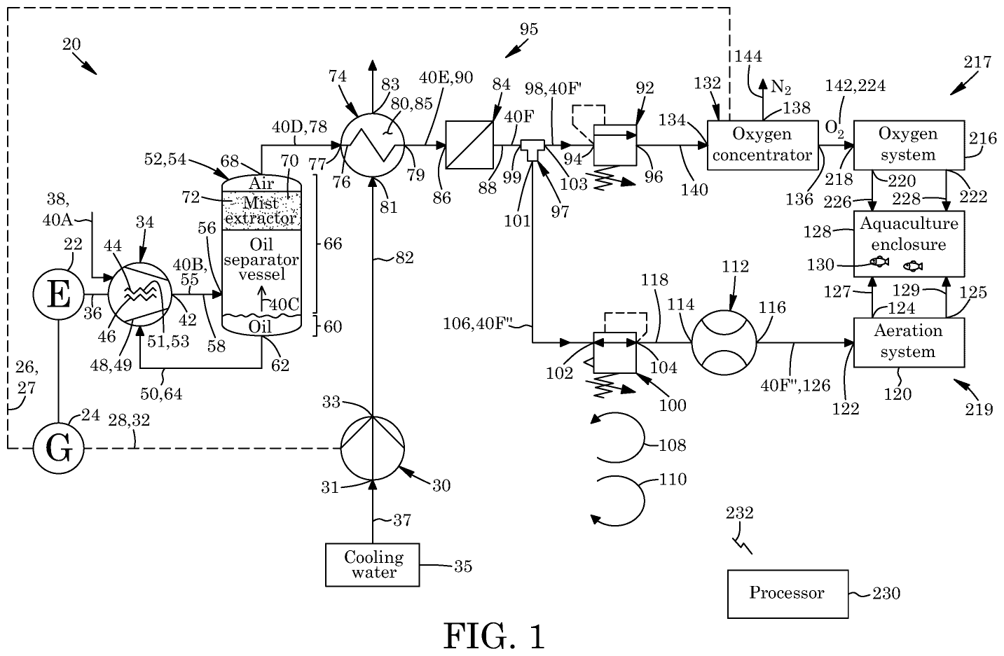

Referring to the drawings and first to FIG. 1, there is shown an aquaculture assembly 20. The aquaculture assembly is configured to selectively generate compressed air and concentrated oxygen, and may be referred to as an aquaculture assembly for generating compressed air and concentrated oxygen. Aquaculture assembly 20 may also be referred to as a system for co-generating concentrated oxygen and compressed air in low-pressure applications.

The aquaculture assembly includes a prime mover, in this example an engine, in this case a variable speed engine 22. The variable-speed engine functions as the prime mover for the entire aquaculture assembly in this example. Engine 22 is a diesel engine in this example; however, this is not strictly required.

Aquaculture assembly 20 includes an alternator 24. The alternator is operatively connected to and powered by engine 22. The engine is in direct mechanical commutation with the alternator in this example. Alternator 24 so powered may output electricity, in this example alternating electricity as shown by numerals 26 and 28.

Aquaculture assembly 20 includes a pump, in this example a water pump 30, in this case a direct current (DC) water pump; however, the latter is not strictly required. The pump operatively connects to and is powered by alternator 24 in this example. This is shown by electrical conduit or wire 32 electrically coupling together pump 30 and alternator 24, with the alternator providing electricity as shown by numeral 28 thereto. The pump has an inlet 31 and an outlet 33 spaced-apart from the inlet thereof. The inlet of the pump is arranged to receive therethrough water, in this example cooling water 35 via conduit 37. Pump 30 selectively outputs the cooling water via outlet 33 thereof.

Aquaculture assembly 20 includes a compressor, in this example a gas compressor, in this case a screw compressor, in this non-limiting embodiment an oil-injected, rotary screw compressor 34. However, the latter is not strictly required, and a compressor that is not a screw compressor and/or which is without oil injection may be used in other embodiments for example. Compressor 34 has a low volume ratio (Vi) in this example; however, here too this may not strictly be required. Engine 22 directly couples to, drives and powers the compressor, in this example via drive shaft 36. The engine is in direct mechanical commutation with compressor 34.

The compressor has an inlet 38 configured to receive air at a first or lower pressure, in this example air 40A at a first or lower pressure, in this case atmospheric pressure. Compressor 34 has an outlet 42 spaced-apart from the inlet thereof. The compressor is a positive displacement machine that includes two closely meshed helical screws or rotors 44 and 46 enclosed within walls 48 of a housing 49. Chambers 51 and an air end 53 are formed between the rotors and walls of the housing. As rotors 44 and 46 turn, the chamber volume decreases towards outlet 42 of compressor 34. The compressor compresses the air 40A to a compressed state thereby, with compressed air 40B having a second or higher pressure compared to the first or lower pressure, in this non-limiting embodiment atmospheric pressure.

Oil 50 is injected into compressor 34 and may function to lubricate points of contact, seal gaps and cool the air. The compressor inducts atmospheric (free) air and injects oil into air during compression. Injection of oil 50 may lower the output air temperature significantly by transferring the heat of compression of the air to the oil. Compressors in general including oil-injected compressors, their various parts and functionings, are known per se and compressor 34 will accordingly not be described in further detail.

A bi-phase flow 55 of oil 50 and compressed air 40B is outputted from the compressor. The liquid and gas may then separated by known techniques. Aquaculture assembly 20 includes in this non-limiting example a gas-liquid separator, in this case air-oil separator 52 positioned to receive bi-phase flow 55 of oil 50 and compressed air 40B. The air-oil separator operatively connects to and is downstream of compressor 34. Air-oil separator 52 includes in this non-limiting embodiment a vessel 54 with an inlet 56. The inlet of the vessel is in fluid communication with outlet 42 of compressor 34 via conduit 58 in this example. Vessel 54 in this non-limiting embodiment includes a first or lower portion 60 configured to collect oil 50 via gravity after being cooled. The vessel has a first or oil outlet 62 in fluid communication with the lower portion thereof. The oil outlet of vessel 54 is in fluid communication with compressor 34 via conduit 64. The conduit is configured to re-circulate oil 50 so collected to the compressor.

Vessel 54 includes a second or upper portion 66 spaced-apart from lower portion 60 thereof. The upper portion of the vessel is configured to collect compressed air 40C therewithin. Vessel 54 has a second or air outlet 68 in fluid communication with upper portion 66 thereof. Air-oil separator 52 in this non-limiting embodiment includes a mist extractor 70 within the upper portion of the vessel. The mist extractor spans vessel 54. Mist extractor is positioned inlet 56 and air outlet 68 of vessel 54. Mist extractor 70 is configured to collect small liquid droplets 72 from compressed air 40C prior to the compressor air exiting the vessel via the air outlet. Air outlet 68 of vessel 54 is thus configured to enable compressed air 40D so separated from oil 50 to pass therethrough. Air-oil separator 52 is thus configured to separate the oil from compressed air 40B outputted from compressor 34 and configured to re-circulate the oil so separated to the compressor. Air-oil separators and mist extractors in general, including their various parts and functionings, are known per se to those skilled in the art and air-oil separator 52 and mist extractor 70 will accordingly not be described in further detail.

Aquaculture assembly 20 includes a heat exchanger, in this example a fluid-gas heat exchanger, in this case a fluid-air heat exchanger, in this non-limiting embodiment a liquid-air heat exchanger 74. However, this is not strictly required and the heat exchanger may comprise a fluid-air heat exchanger, where the fluid is a gas and not a liquid in other embodiments, for example. Liquid-air heat exchanger 74 is downstream of compressor 34 and in this example downstream of the air-oil separator 52. Liquid-air heat exchanger 74 operatively connects to the compressor. The liquid-air heat exchanger includes a first passageway, in this example an air passageway 76 to receive compressed air 40D therethrough via an inlet or air inlet 77 thereof. The air inlet may be referred to as a first inlet or air inlet of liquid-air heat exchanger 74. Air passageway 76 of the liquid-air heat exchanger is in fluid communication with air-oil separator 52 via conduit 78 in this example. The air passageway has an outlet, in this example an air outlet 79 spaced-apart from air inlet 77 thereof. The air outlet may be referred to as a first outlet or air outlet of liquid-air heat exchanger 74.

The liquid-air heat exchanger includes a second passageway, in this example a fluid passageway, in this case a liquid passageway 80. The liquid passageway is separate from, adjacent to and in thermal contact with air passageway 76 so to promote transferring of heat from compressed air 40D within the air passageway to liquid 85 within the liquid passageway. Pump 30 is operatively coupled to liquid-air heat exchanger 74. The pump is in fluid communication with an inlet or fluid/liquid inlet 81 of liquid passageway 80 of the liquid-air heat exchanger via conduit 82 in this example. The liquid inlet of the liquid passageway may be referred to as a second inlet or fluid/liquid inlet of liquid-air heat exchanger 74.

Pump 30 is configured to direct and/or re-circulate fluid, in this example liquid, in this non-limiting embodiment cooling water 35 through liquid passageway 80 of liquid-air heat exchanger 74, with the water exiting via an outlet or fluid/liquid outlet 83 of the liquid passageway and compressed air 40E exiting air outlet 79 being cooled thereby. The liquid outlet of the liquid passageway may be referred to as a second outlet or fluid/liquid outlet of the liquid-air heat exchanger.

The cold-side liquid of liquid-air heat exchanger 74 is provided by pump 30 on-board to the overall compressor unit, driven by alternator 24. The liquid-air heat exchanger may thus be referred to as a water-air heat exchanger; however, this is not strictly required and other fluids and/or liquids may be used to cool the compressed air in other embodiments. Liquid-air heat exchanger 74 is thus configured to cool compressed air 40D/40E outputted from compressor 34 and passing therethrough. The liquid air heat exchanger is thus configured such that air passing therethrough is cooled, with water and/or oil vapor condensing out therefrom. Heat-exchangers in general, including their various parts and functionings, are known per se to those skilled in the art and liquid-air heat exchanger will thus not be described in further detail.

Aquaculture assembly 20 in this non-limiting embodiment includes a filtration unit, in this example a static said filtration unit 84. The filtration unit may be referred to as comprising static filtration elements. Filtration unit 84 is configured to receive therethrough the air stream or compressed air 40E. The filtration unit is downstream of liquid-air heat exchanger 74. The filtration unit has an inlet 86 and an outlet 88 spaced-apart from the inlet thereof. The inlet of filtration unit 84 is in fluid communication with outlet 79 of air passageway 76 of liquid-air heat exchanger 74 via conduit 90. The filtration unit is configured to remove water and oil, with the latter being removed down to a certain predetermined threshold or oil carryover rate. Filtration unit 84 may comprise in one non-limiting example a cyclonic separator for bulk water removal and one or more coalescing filters for oil removal. However, this is not strictly required and the filtration unit may comprise one or more of these components and/or alternative components in other embodiments. Filtration unit 84 is configured to output compressed air 40F with oil and/or water so further removed therefrom. Filtration units in general, including cyclonic separators, coalescing filters and the like, including their various parts and functionings, are known per se and filtration unit 84 will accordingly not be described or discussed in further detail.

Engine 22, alternator 24, compressor 34, air-oil separator 52, liquid-air heat exchanger 74, pump 30 and filtration unit 84 so combined and operatively connected together, may be referred to as a first or upstream system 95.

At this point, the air is split in this example via a flow-directing member 97 between two streams: a first portion 40F′ and a second portion 40F″ of compressed air 40F. The flow-directing member may be referred to as a splitter, a divider or a flow-directing passageway or conduit. Flow-directing member 97 may (but need not necessarily) comprise a conduit coupling and/or three-way valve with one inlet 99 in fluid communication with outlet 88 of filtration unit 84, and a pair of outlets 101 and 103 in communication with the inlet thereof. The split between first portion 40F′ and second portion 40F″ of compressed air 40F may range from between 0-100% and 100-0%, depending on configuration of flow-directing member 97 and/or aquaculture assembly 20 and given needs or requirements thereof.

The aquaculture assembly includes in this non-limiting embodiment a first valve, in this example a minimum pressure valve 92. The minimum pressure valve operatively connects to and is downstream of filtration unit 84 in this example. Minimum pressure valve 92 has an inlet 94 and an outlet 96 spaced-apart from the inlet thereof. The inlet of the minimum pressure valve is in fluid communication with filtration unit 84 via conduit 98 in this example. Minimum pressure valve 92 is thus also downstream of and in fluid communication with compressor 34, air-oil separator 52 and liquid-air heat exchanger 74. The minimum pressure valve is configured to enable first portion 40F′ of compressed air 40F from compressor 34 to pass therethrough.

Minimum pressure valve 92 functions in part as a check valve to inhibit a backflow of compressed air into the air end of compressor 34. The minimum pressure valve is configured to retain a minimum pressure in the compressor to promote lubrication and functioning of the compressor. Minimum pressure valve 92 may function to maintain/promote a continuous pressure upstream thereof between outlet 42 of compressor 34 and this valve. A fluctuating pressure over air-oil separator 52 may have undesirable impacts on the quantity of oil lost downstream. Too low of a pressure may reduce the ability to achieve a target temperature in liquid-heat exchanger 74, as the residence time within the exchanger may decrease. A too-low pressure may also result in overflowing of filtration unit 84 or components thereof. Minimum pressure valve 92 may be referred to as a single stage pressure relief valve which opens above a set pressure and closes below it.

Aquaculture assembly 20 includes in this non-limiting embodiment a second valve, in this example in the form of a forward pressure regulator 100. The forward pressure regulator operatively connects to and is downstream of filtration unit 84 in this example. Forward pressure regulator 100 has an inlet 102 and an outlet 104 spaced-apart from the outlet thereof. The inlet of the forward pressure regulator is in fluid communication with outlet 88 of filtration unit 84 via conduit 106 in this example. Forward pressure regulator 100 is thus also downstream of and in fluid communication with compressor 34, air-oil separator 52 and liquid-air heat exchanger 74.

The forward pressure regulator is configured to selectively increase downstream pressure when incrementally actuated, rotated in a first direction of rotation 108 or opened. Forward pressure regulator 100 is configured to selectively decrease downstream pressure when incrementally rotated in a second direction of rotation 110 (opposite the first direction of rotation) or closed. The forward pressure regulator may be configured to reduce higher supply pressure at inlet 102 thereof to a lower outlet pressure at outlet 104 thereof and may control downstream pressure. Forward pressure regulator 100 is configured to enable second portion 40F″ of compressed air 40F from compressor 34 to pass therethrough.

Aquaculture assembly 20 in this non-limiting embodiment includes a flow meter 112; however, this is not strictly required. The flow meter operatively connects to and is in this example downstream of forward pressure regulator 100. Flow meter 112 has an inlet 114 and an outlet 116 spaced-apart from the inlet thereof. The inlet of the flow meter is in fluid communication with forward pressure regulator 100 via conduit 118 in this example. Flow of second portion 40F″ of compressed air 40F passing by flow meter 112 is monitored by the flow meter and compared against the overall flow rate of compressed air 40F from compressor 34 to determine flow splitting rates between portions 40F′ and 40F″ of the compressed air.

Aquaculture assembly 20 is connectable to and/or may be said to include an aeration system 120. The aeration system operatively connects to and is downstream of forward pressure regulator 100 as well as downstream of flow meter 112 in this example. Aeration system 120 has an inlet 122 via which second portion 40F″ of compressed air 40F is received and one or more outlets 124 and 125 spaced-apart from the inlet thereof. The inlet of the aeration system is in fluid communication with outlet 116 of the flow meter via conduit 126 in this example. Forward pressure regulator 100 is thus connectable to and in fluid communication with inlet 122 of acration system 120 via conduits 118 and 126 in this example. Second portion 40F″ of compressed air 40F is thus diverted towards the acration system through forward pressure regulator 100. The regulated pressure of the acration system line (conduits 106, 118 and 126) may directly determine the flowrate throughput to the acration system.

Aquaculture assembly 20 is connectable to and/or may be said to include an aquaculture enclosure 128. The aquaculture enclosure may comprise a net cage, net pen or other such enclosure configured to enclosed therewithin one or more aquatic species to be farmed, such as fish 130. Outlets 124 and 125 of acration system 120 may be located adjacent or within aquaculture enclosure 128. In addition or alternatively, the outlets of the aeration system may be in fluid communication with the aquaculture enclosure via conduits 127 and 129. Second portion 40F″ of compressed air 40F is selectively directed to aeration system 120 and/or aquaculture enclosure 128 via compressor 34, after passing through air-oil separator 52, liquid-air heat exchanger 74, filtration unit 84, forward pressure regulator 100 and flow meter 112 in this example. The compressor is thus operatively connected to aeration system 120 and configured to selectively direct compressed air thereto.

Still referring to FIG. 1, aquaculture assembly 20 includes an oxygen concentrator, in this example a pressure swing adsorption said oxygen concentrator, in this case a low pressure swing adsorption said oxygen concentrator 132. However, the latter is not strictly required and other types of oxygen concentrators may be used in other embodiments. Oxygen concentrator 132 may be referred to as an oxygen generator. The oxygen concentrator operatively connects to and is powered by alternator 24 in this example. This is shown by electrical conduit or wire 27 electrically coupling together the alternator and oxygen concentrator 132, with the alternator providing electricity as shown by numeral 26 thereto. The oxygen concentrator has an inlet 134, a first or oxygen outlet 136 and a second or exhaust outlet 138. The outlets of oxygen concentrator 132 are spaced-apart from the inlet of the oxygen concentrator. Exhaust outlet 138 may be referred to or include an exhaust muffler; however, this is not strictly required. Outlet 96 of minimum pressure valve 92 operatively connects to and in fluid communication with inlet 134 of oxygen concentrator 132 via conduit 140 in this example. Power consumption from aquaculture assembly 20 is primarily tied to and based on upstream system 95. Electricity consumption from oxygen concentrator 132, including control assemblies thereof, may be considered negligible.

Aquaculture assembly 20 is configured such that excess flow of compressed air not consumed by acration system 120 is passed to the concentrator section via minimum pressure valve 92. The minimum pressure valve is configured to actuate upon being subjected to a pressure equal to or greater than a predetermined threshold of pressure indicative an excess portion of compressed air not being consumed by the acration system. First portion 40F′ of compressed air 40F is thus selectively directed to oxygen concentrator 132 from compressor 34, after passing through air-oil separator 52, liquid-air heat exchanger 74, filtration unit 84, and the minimum pressure valve in this example. The compressor is thus operatively connected to the oxygen concentrator and configured to selectively direct compressed air thereto.

Oxygen concentrator 132 functions to concentrate oxygen 142 from a gas supply, in this example first portion 40F′ of the compressed air, by selectively removing nitrogen 144 therefrom. This results in a gas output comprising oxygen-enriched gas.

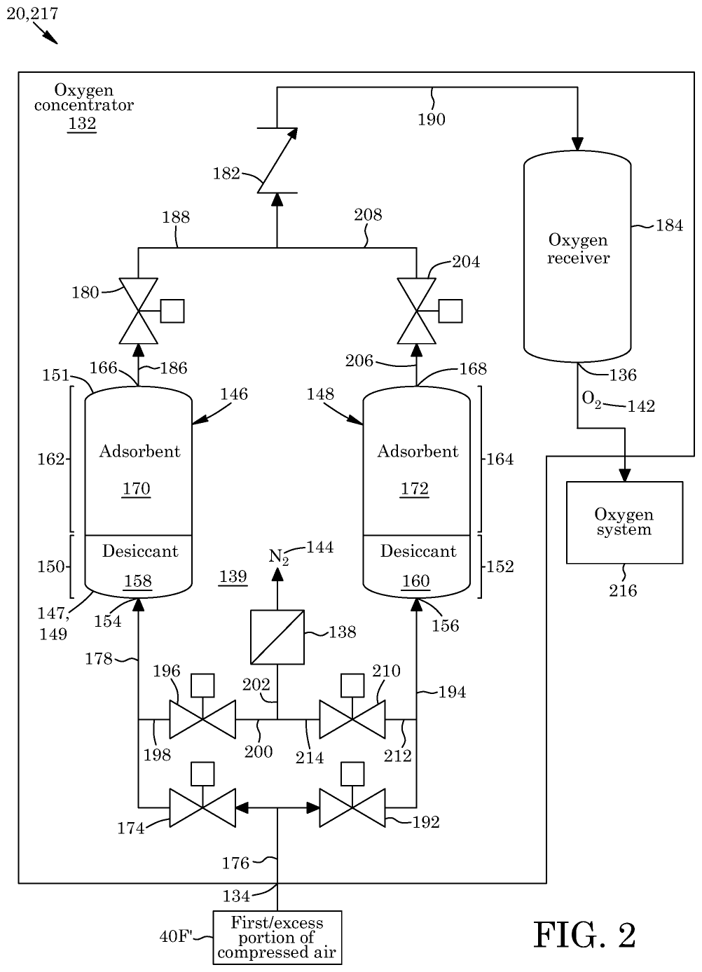

FIG. 2 illustrates a non-limiting example of oxygen concentrator 132 in more detail. The oxygen concentrator includes at least one and in this example a pair of vessels, namely, first vessel 146 and second vessel 148 via which first portion 40F′ of the compressed air is selectively received. The vessels may be referred to as a columns. Vessels 146 and 148 have first or lower portions 150 and 152 and inlets 154 and 156 in fluid communication with the lower portions thereof. The inlets are positioned to selectively receive first portion 40F′ of the compressed air therethrough. Vessels 146 and 148 include desiccants 158 and 160 therewithin. The desiccants are positioned in lower portions 150 and 152 of the vessels in this example and are in fluid communication with inlets 154 and 156. Desiccants 158 and 160 are configured to receive a lower input humidity load.

Vessels 146 and 148 have second or upper portions 162 and 164 in fluid communication with lower portions 150 and 152 thereof. The vessels have outlets 166 and 168 in fluid communication with the upper portions thereof. Vessels 146 and 148 include adsorbents 170 and 172 therewithin. Each adsorbent comprises in this non-limiting embodiment a bed of zeolite, in this case high-performance zeolite. Desiccants 158 and 160 are positioned to dehumidify first portion 40F′ of the compressed air prior to being directed towards adsorbents 170 and 172. Each vessel 146 is thus filled with a dual-layer medium 147 composed of or comprising: desiccant 158 on or adjacent bottom 149 thereof; and adsorbent 170 on or adjacent top 151 thereof. The incoming first portion 40F′ of compressed air may still be of high humidity, and the desiccant provides a final dehumidifying step before the air is passed into the adsorbent.

In operation, oxygen concentrator 132 includes a first control valve 174 which is selectively opened so as to direct first portion 40F′ of compressed air along path or one or more conduits 176 and 178 towards inlet 154 of first vessel 146 with outlet 166 thereof being closed so as to fill the first vessel. This increases the pressure within the first vessel, causing nitrogen to be adsorbed by adsorbent 170 and resulting in gas of enriched oxygen. The adsorbent thus separates the nitrogen out of the air stream, purifying the oxygen into the output concentrated oxygen stream. Outlet 166 of first vessel 146 is selectively opened, and a second control valve 180 as well as check valve 182 may then be selectively opened to enable gas of enriched oxygen 142 to pass through to oxygen receiver 184 for storage thereof via one or more conduits 186, 188 and 190. This process may slowly reduce the pressure within the first vessel and may be referred to as a blowdown portion of the cycle. Oxygen receiver 142 is not be strictly required and other embodiments need not include the same.

First portion 40F′ of the compressed air is then directed to second vessel 148 by closing inlet 154 to first vessel 146 and first control valve 174, ensuring outlet 168 of the second vessel is closed and opening inlet 156 to the second vessel as well as third control valve 192 so as to enable the compressed air to pass the second vessel via one or more conduits 176 and 194. As the second vessel becomes full of compressed air, the second vessel is subject to an increase in pressure that promotes adsorption of nitrogen from the air to adsorbent 172. Meanwhile, lowering the pressure within first vessel 146 will overtime cause nitrogen to be re-released from adsorbent 170 and into the first vessel. The nitrogen gas so released into the first vessel is selectively removed from oxygen concentrator 132 by opening a fourth control valve 196 (in fluid communication with inlet 154) so as to direct the enriched concentration of nitrogen towards exhaust outlet 138 via one or more conduits 178, 198, 200 and 202. The exhaust outlet is exposed to atmosphere 139 in this non-limiting embodiment; however, this is not strictly required. This may be referred to as a purge portion of the cycle, with desiccants 158 being regenerated during the blowdown and purge portions of the cycle. The desiccant, liquid-air heat-exchanger 74, filtration unit 84 and oxygen concentrator 132 seen in FIG. 1 may be referred to as an oxygen generating assembly. Control valve 180 in this example atop non-producing vessel 146 may open a small amount after initial exposure to atmosphere to reject the nitrogen gas filling the vessel and replace it with expanded oxygen gas from producing vessel 148.

Outlet 168 of second vessel 148 is selectively opened, and a fifth control valve 204 as well as check valve 182 may then be selectively opened to enable gas of enriched oxygen 142 to pass therethrough to oxygen receiver 184 via one or more conduits 206, 208 and 190. This process will slowly reduce the pressure within the second vessel. First portion 40F′ of the compressed air is next once more directed to first vessel 146 by closing one or more of inlet 156 to second vessel 148 and third control valve 192, ensuring outlet 166 of the first vessel is closed and opening inlet 154 to the first vessel as well as first control valve 174 so as to enable the compressed air to pass to the first vessel via one or more conduits 176 and 178. This causes the first vessel to become full of compressed air, increasing pressure therewithin and promoting adsorption of nitrogen from the air to adsorbent 170 once more. Meanwhile, lowering pressure within second vessel 148 will overtime cause nitrogen to be re-released from adsorbent 172 and into the second vessel. The nitrogen gas so released is selectively removed from oxygen concentrator 132 by opening a sixth control valve 210 (in fluid communication with inlet 156) so as to direct the enriched concentration of nitrogen towards exhaust outlet 138 via one or more conduits 194, 212, 214 and 202. Each of control valves 174, 180, 192, 196, 204 and 210 is an electronically controlled and/or motorized said control valve in this example to facilitate selective control and actuation thereof.

This process is repeated with first portion 40F′ of the compressed air alternating between first vessel 146 and second vessel 148 so as to selectively promote adsorption of nitrogen and resulting oxygen enriched gas in one vessel and the release of nitrogen to form nitrogen enriched gas in the other vessel and vice versa. The oxygen-enriched gas may be selectively extracted from one vessel while the nitrogen enriched gas in the other vessel may be purged from oxygen concentrator 132 and vice versa. Oxygen concentrator 132 is thus configured to enable a near continuous production of oxygen. Oil-free, dried air 40F′ is thus fed continuously into either vessel 146 and 148, with electronic valving on the adsorbent vessels running the pressure swing adsorption (PSA) cycle.

The cycling process and valving configuring of oxygen concentrator 132 generally in this non-limiting embodiment is implemented as a pressure swing adsorption (PSA) six-step Skarstrom cycle and known per se, composed of the standard pressurization, feed, depressurization, blowdown, purge and equalization steps. It will accordingly not be described in further detail.

Referring to FIG. 1, aquaculture assembly 20 is connectable to and/or may be said to include an oxygen system 216; however, the latter is not strictly required. The oxygen system is downstream of minimum pressure valve 92 as well as downstream of oxygen concentrator 132 in this example. Oxygen system 216 operatively couples to oxygen receiver 184 in this example; however, this is not strictly required and the oxygen system may couple directly to the oxygen concentrator in other embodiments. The oxygen system has an inlet 218 via which gas of enriched oxygen 142 is received and one or more outlets 220 and 222 spaced-apart from the inlet thereof. The inlet of the oxygen system is in fluid communication with oxygen outlet 136 of oxygen concentrator 132 via conduit 224 in this example. Outlets 220 and 222 of oxygen system 216 may be located adjacent or within aquaculture enclosure 128. In addition or alternatively, the outlets of the oxygen system may be in fluid communication with the aquaculture enclosure via conduits 226 and 228. Gas of enriched oxygen 142 is thus selectively directed to oxygen system 216 and/or aquaculture enclosure 128 via compressor 34, air-oil separator 52, liquid-air heat exchanger 74, filtration unit 84, minimum pressure valve 92 and oxygen concentrator 132 in this example.

The compressor is thus operatively connected to oxygen system 216 and configured to selectively direct compressed air to the oxygen concentrator. Compressor 34 is therefore operatively connected to both aeration system 120 and oxygen concentrator 132 and configured to selectively direct compressed air 40B/40C/40D/40E/40F′/40F″ to either or both thereof. Selective adjustment of the speed of engine 22 enables on-the-fly and/or real-time adjustment of one or more of the acration system or the oxygen concentrator. Selective adjustment of the speed of the engine enables on-the-fly and/or real-time adjustment of the split between acration and oxygen production while inhibiting losses due to throttling or start-stop operation of compressor 34. In operation, actuation of minimum pressure valve 92 and/or forward pressure regulator 100 enable compressed air to be directed to one or more of aeration system 120 or oxygen concentrator 132. Aquaculture assembly 20 as herein described may thus be said to include a means to co-generate compressed air and concentrated oxygen continuously, and on-demand and in real-time modify the split ratio between the compressed air and the concentrated oxygen.

Flow-directing member 97, or compressed air upstream thereof arising from compressor 34, may be said to comprise a single source of compressed air. Aeration system 120 and oxygen concentrator 132 are thus operatively and/or selectively in communication said single source of compressed air.

Aquaculture assembly 20 includes a processor 230 which may be powered by electricity from alternator 24. As shown by signal sign of numeral 232, the processor may operatively connect to, be in communication with and/or selectively control, adjust and/or actuate engine 22, compressor 34, pump 30, minimum pressure valve 92, forward pressure regulator 100, flow meter 112, aeration system 120, oxygen concentrator 132 (including control valves 174, 180, 192, 196, 204 and 210 seen in FIG. 2), and/or oxygen system 216. However, processor 230 may not strictly be required and in other embodiments aquaculture assembly 20 may not include a processor.

Referring to FIG. 1, minimum pressure valve 92, oxygen concentrator 132 and/or oxygen system 216 may be referred to as a first downstream system 217. Forward pressure regulator 100, flow meter 112 and/or aeration system 120 may be referred to as a second downstream system 219.

Still referring to FIG. 1, there is also provided a method of generating concentrated oxygen 142 and compressed air 40F for aquaculture. The method includes directly coupling variable speed engine 22 to compressor 34 so as to output compressed air 40B. The method may include using an oil-injected said compressor, with the method further including removing oil 50 from the compressed air via air-oil separator vessel 52 and/or mist extractor 70, and thereafter re-circulating the oil so captured to the compressor.

The method may include removing humidity from compressed air 40C/40D via liquid-air heat exchanger 74. In addition or alternatively, the method may also include removing humidity from the compressed air via filtration unit 84. The method may further include removing fluid from compressed air 40E/40F via a cyclonic separator and/or and one or more coalescing filters. As seen in FIG. 2, the method includes additionally removing humidity via desiccant 158/160. The method may include positioning the desiccant within one or more vessels 146 and 148 of oxygen concentrator 132.

As seen in FIG. 1, the method includes selectively directing first portion 40F′ of compressed air 40F so dehumidified to oxygen concentrator 132 seen in FIG. 2. Referring back to FIG. 1, the method include directing the first portion of the compressed air so dehumidified to the oxygen concentrator via flow-directing member 97, which may comprise a three-way valve. The method may include positioning a first valve or minimum pressure valve 92 between outlet 42 of compressor 34 and inlet 134 of oxygen concentrator 132 seen in FIG. 2.

As seen in FIG. 1, the method includes selectively directing second portion 40F″ of compressed air 40F so dehumidified to aeration system 120. The method include directing the second portion of the compressed air so dehumidified to the aeration system via flow-directing member 97, which may comprise a three-way valve. The method may include positioning a second valve or forward pressure regulator 100 between outlet 42 of compressor 34 and inlet 122 of aeration system 120.

The method may include lowering an oxygen production pressure of oxygen concentrator 132 to be closer in value to an air system operating pressure of the aeration system. The method may include adjusting an oxygen production pressure of the oxygen concentrator to be equal within a predetermined threshold, to an air system operating pressure of the aeration system. The method includes adjusting the split between aeration and oxygen production at least in part by selectively adjusting one or more of minimum pressure valve 92 or forward pressure regulator 100. The method includes adjusting the split between aeration and oxygen production on-the-fly, on demand and/or in real-time. The method includes adjusting the split between aeration and oxygen production at least in part by adjusting the speed of engine 22.

There is thus further provided a method of generating compressed air 40B/40C/40D/40E/40F for aquaculture assembly 20. The method includes providing motive power via variable speed engine 22. The method includes powering compressor 34 via the variable speed engine. The method includes outputting compressed air 40B/40C/40D/40E/40F via the compressor.

There is also therefore provided a method of generating oxygen 142 for aquaculture. The method includes directing compressed air 40D through liquid-air heat exchanger 83 so as to cool the compressed air. The method includes directing compressed air 40E so cooled through filtration unit 84 to remove liquid therefrom. The method includes outputting oxygen 142 via oxygen concentrator 132 seen in FIG. 2 downstream of the filtration unit. The method may include dehumidifying the compressed air via desiccants 158 and 160 positioned downstream of filtration unit 84 seen in FIG. 1. Referring back to FIG. 2, the method may include positioning one or more said desiccants within one or more said vessels 146 and 148 of oxygen concentrator 132. The method may include selectively adsorbing nitrogen 144 within the oxygen concentrator via adsorbents 170 and 172 downstream of desiccant.

Many advantages may result from the structure and configuration of aquaculture assembly 20 as herein described. For example, the aquaculture assembly as herein described enables only one prime mover or engine 22 to be needed to supply either aeration, oxygenation, or a combination of both to the user's demands. Aquaculture assembly 20 as herein described may be capable of creating and delivering both compressed air and high-purity oxygen simultaneously and/or on-site. The aquaculture assembly may thus be used in three different configurations: (1) oxygen delivery only, (2) air delivery only, or (3) simultaneous delivery of compressed oxygen and air. Aquaculture assembly 20 may be adjusted between these three conditions with little to substantially no downtime. The aquaculture assembly as herein described may comprise a unique implementation in which both gases (oxygen and/or air) can be generated simultaneously via the aquaculture assembly as herein described. This may be achieved by via a unique arrangement of flow flitting/splitting and lowering the oxygen production pressure closer to air system operating pressures for example.

Aquaculture assembly 20 as herein described may result in a significant reduction in fuel consumption for generating either air or oxygen. Traditional electric compressors may have internal compression ratios for 125 psig, meaning that output pressures below the same may not significantly reduce energy consumption. In contrast, oxygen concentrator 132 seen in FIG. 2 and as herein described may produce air or oxygen at a reduced pressure of less 125 psig, such as at only 45 psig according to one non-limiting example, which may provide significant savings over the traditional setup. Aquaculture assembly 20 as herein described may deliver both compressed air and oxygen from a single primary compression device towards reduced or lowest pressures to run standard aquaculture applications. This may function to optimize fuel consumption while having a significantly reduced capital expenditure compared to two separate and stand-alone systems.

Aquaculture assembly 20 as herein described may result in a significant reduction in the number of major units required for an aquaculture site requiring both aeration and oxygenation. The need for a generator may be eliminated and the motor inside the traditional electric compressor is eliminated. Some installations feature a variable frequency drive on the compressor, which is not required in this installation. The major unit of a refrigerated dryer of prior art systems is replaced with a minor unit of a small internal heat exchanger 74, eliminating the power consumption of that unit. The air receiver of prior art systems is eliminated due to properly timing the pressure swing adsorption cycle to the input flow arising from the upstream components of aquaculture assembly 20.

The unit may achieve variable capacity at no additional expense through use of a variable-speed diesel engine. This may enable the unit to achieve fuel savings through output turndown. Variable-speed engine 22 directly couples to compressor 34 in aquaculture assembly 20 as herein described. This may be in contrast with prior art systems which use an engine and generator (genset) to produce electrical power, which may then be used to power a motor and variable frequency drive, which in turn powers a compressor and which includes electrical transmission wiring. By implementing a direct coupling between engine 22 and compressor 34, the genset, variable frequency drive, electrical transmission wiring and motor used in the state-of-the-art may thus be eliminated. In remote locations without access to grid electricity, aquaculture assembly 20 as herein described and so configured, may provide significant fuel savings as the electrical conversion losses are eliminated.

The possibility of the traditional electric system suffering from a mismatched generator to load size may be eliminated in this setup, as engine 22 is well suited for output over the entire operating range. In a traditional setup, a generator too large for a load being consumed may run at poor thermal efficiency. Thus, the possibility of poor fuel economy from mismatching of the genset size and load may also be eliminated

Aquaculture assembly 20 as herein described may be said to comprise a single compressor 34 configured to generate the required air for both aeration and oxygenation systems in an efficient manner. This may be in contrast to prior art systems which use two compressors: one compressor for its aeration system and one compressor for its oxygenation system. Using a common compressor capable of generating either air or oxygen results in the ability to utilize a single compressor backup for these two systems. Aquaculture assembly 20 as herein described may thus comprise a single unit continuously outputting a split between air and oxygen via a single compressor.

Oxygen concentrators typically implement variable capacity by operating the compressor on a stop-start cycle, keeping a large air tank before the concentrator within a set pressure range. The concentrator then decides how much air to induct, and the compressor runs for more or less time depending on this decision. In contrast, aquaculture assembly 20 as herein described utilizes variable-speed engine 22 seen in FIG. 1 to change the overall output of compressor 34, leading to aquaculture assembly 20 as herein described which does not require an air-receiver to achieve different flow rates. Changing the engine speed is an efficient way to lower air production, as power required, and air produced will scale approximately linearly. Variable output through speed turndown of engine 22 of aquaculture assembly 20 as herein described may also enable on-the-fly adjustment of the split between aeration and oxygen production without any losses due to compressor throttling or start-stop operation.

Aquaculture assembly 20 as herein described provides an oxygen generating assembly comprising liquid-air heat exchanger 74, filtration unit 84 and desiccants 158 and 160 of oxygen concentrator 132 seen in FIG. 2. This is in contrast to prior art pressure swing adsorption systems that use a refrigerated dryer in place of the heat exchanger and filtration, which may require a significant amount of high-voltage AC power to operate, necessitating an available electrical supply. Aquaculture assembly 20 as herein described may eliminate the above components and requirements by implementing two-step dehumidification, namely, heat exchange with filtration and desiccant in the oxygen concentrator. Most of the humidity may be removed via liquid-air heat exchanger 74 seen in FIG. 1 and a final low-dew point may be reached with desiccants 158 and 160 seen in FIG. 2. The desiccants may require a lower input humidity load, thereby creating a symbiotic relation for this process.

This change in aquaculture assembly 20 as herein described enables the power consumption from a dryer (and the need for high-voltage AC) to be eliminated. The normally rejected nitrogen-rich gas from oxygen concentrator 132 seen in FIG. 2 may thus be used to freely regenerate desiccants 158 and 160 seen in FIG. 2. This change enables aquaculture assembly 20 to use a DC water pump 30 in combination with a standard engine alternator 24 to lower the overall power required to dry the product air and eliminate the refrigerated dryer completely.

Aquaculture assembly 20 as herein described may operate at a lower pressure by means of compressor 34 with a low-volume ratio (Vi). This may lead to major fuel savings over standard high-pressure compressor. The performance loss for oxygen generation from operating at a lower pressure ratio may be offset by using adsorbents 170 and 172 seen in FIG. 2 in the form of high-performance zeolite.

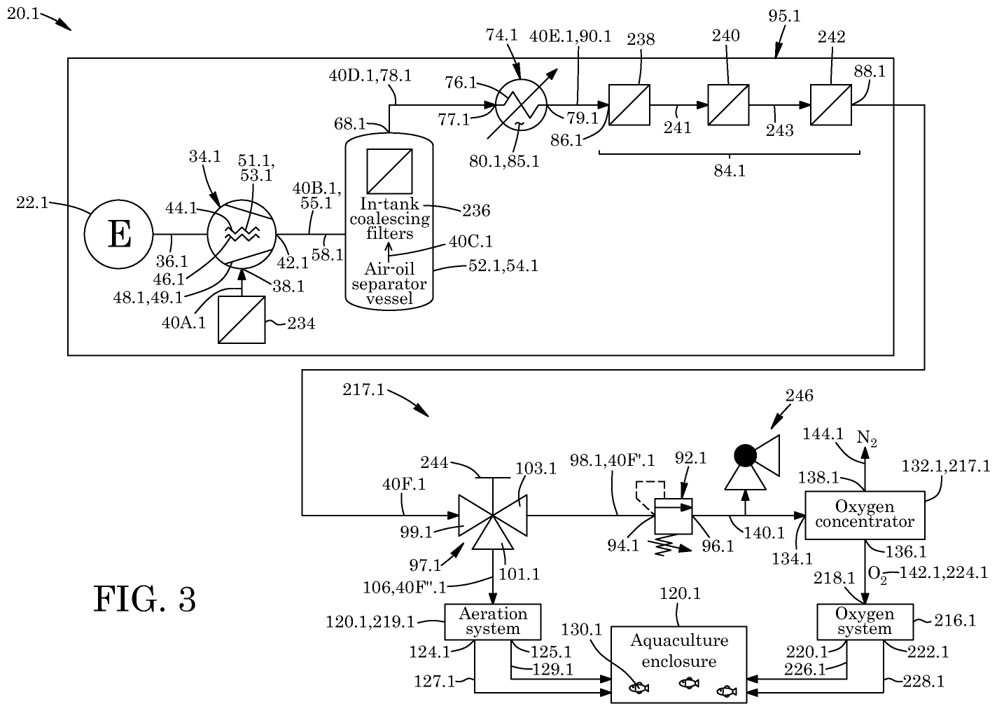

FIGS. 3 to 5 show an aquaculture assembly 20.1 according to another aspect. Like parts have like numbers and functions as aquaculture assembly 20 shown in FIGS. 1 to 2 with the addition of decimal extension “.1”. Aquaculture assembly 20.1 is substantially the same as aquaculture assembly 20 shown in FIGS. 1 to 2 with at least the following exceptions.

Engine 22.1 directly drives compressor 34.1. The engine in one non-limiting example comprises a continuous-duty 6.7 L inline-6 142 kW diesel engine; however, this is not strictly required and other types of engines with other configurations or specifications may be used in other embodiments.

Aquaculture assembly 20.1 includes an intake air filter 234 in this non-limiting embodiment. Free air 40A.1 is inducted into compressor 34.1 through the intake air filter. The air is mixed with oil to internally lubricate the compressor and reduce temperatures of output air 40B.1. The air is compressed in one non-limiting example to 45 psig; however, this is not strictly required and the air may be compressed to a lesser or greater pressure in other embodiments. Compressor 34.1 in one non-limiting example has internal volume ratio of 2.7 to provide a 45 psig minimum output pressure; however here too this is not strictly required and the compressor may have other internal volume ratios in other embodiments. The mixture of oil-air or bi-phase flow 55.1 of oil 50.1 and compressed air 40B.1 is released from the compressor at a temperature in this non-limiting example of approximately 80° C.; however this is not strictly required and the mixture of oil-air may be released from the compressor at higher or lower temperatures in other embodiments.

The air-oil mixture is passed into air-oil separator 52.1 comprising vessel 54.1, where gravity separation removes a majority of oil 50.1 in this example. The air-oil separator in this non-limiting embodiment includes one or more in-tank coalescing filters 236. The coalescing filters are configured to remove or reduce the amount of a small remaining minority of oil 50.1. At outlet 68.1 of vessel 54.1, the air temperature in one non-limiting example may be approximately 80° C., with the oil content in exiting air 40D.1 comprising approximately 5 mg/m3, and with a relative humidity of approximately 5 to 10%, depending on ambient air humidity. As before, these values are being provided for illustrative/example purposes only, are not strictly required and may be or less in other embodiments.

Next, the air stream or compressed air 40D.1 is passed to through a fluid-air heat exchanger, in this example a liquid-air heat exchanger 74.1, which in this case comprises a seawater-air heat exchanger. Air is cooled in one non-limiting example to 30° C. by a pumped seawater stream; however, this is not strictly required, other fluids/liquids may be used and the air may be cooled to a higher or lower temperature in other embodiments. This lowering of the temperature of compressed air 40D.1/40E.1 may cause a large amount of humidity to condense out of the air, raising the relative humidity to 100% in one non-limiting embodiment but significantly lowering the absolute humidity.

Filtration unit 84.1 in this non-limiting embodiment includes a water separator 238 to which this cooled air stream or compressed air 40E.1 is directed. The water separator is configured to remove the majority of bulk condensate generated, such as 99% thereof in one non-limiting example; however, the latter is not strictly required. This step may also in one non-limiting example remove approximately 60% of the water vapor from the initial air stream or compressed air 40A.1/40B.1; however, here too this amount is not strictly required and may be more or less in other embodiments. Oil content in the air may be largely unaffected.

Filtration unit 84.1 includes in this example a first coalescing filter, in this example a coarse coalescing filter 240 to which the air stream is directed from water separator 238 via conduit 241 in this example; however the latter is not strictly required. The coarse coalescing filter may comprise a 1-micron filter in one non-limiting example. Filter 240 coalesces some of the remaining oil out of the air, lowering the oil content in the air to approximately 0.3 mg/m3 in one non-limiting embodiment.

Filtration unit 84.1 includes in this example a second coalescing filter, in this example a fine coalescing filter 242 to which the air stream is directed from coarse coalescing filter 240 via conduit 243 in this example; however, the latter is not strictly required. The air may thus be cleaned of oil one additional time in this example via the fine coalescing filter. Fine coalescing filter 242 may comprise in one non-limiting example a 0.01-micron coalescing filter. This may lower the oil content in the air to approximately 0.01 mg/m3 in one non-limiting embodiment. Thus, at outlet 88.1 of filtration unit 84.1, compressed air 40F.1 may in one non-limiting example comprise a 45-psig stream of air at 30° C., 100% relative humidity, and 0.01 mg/m3 oil content; however, as mentioned before these values are not strictly required, are recited for example/illustrative purposes only, and may be different in other embodiments.

Aquaculture assembly 20.1 includes a flow-directing member in the form of a three-way valve, in this example a 3-way directional control valve 97.1. The three-way valve may be referred to as a three-way flow direction valve. The orientation of valve 97.1 (as for example determined by actuation of valve handle 244) determines the extent to which the flow of compressed air is directed away from the oxygen production stream as shown by oxygen concentrator 132.1, and towards aeration system 120.1 or vice versa. Upstream system 95.1 is held at a constant pressure in this non-limiting embodiment, thus removing the necessity of a pressure regulator to drive the aeration system. Valve 97.1 may be adjusted to send full flow to acration system 120.1, full flow to oxygen production via oxygen concentrator 132.1, or any middle value or value therebetween. Three-way valves, including their various parts and functionings, are known per se and three-way valve 97.1 will accordingly not be described in further detail.

The flow or first portion 40F′.1 of the compressed air directed via the three-way valve towards oxygen concentrator 132.1, next encounters minimum pressure valve 92.1. The minimum pressure valve is configured to ensure that a minimum pressure is maintained across components of upstream system 95.1 between compressor 34.1 and three-way valve 97.1. In this non-limiting embodiment the minimum pressure is 45 psig; however, this pressure value is not strictly required and may be higher or lower in other embodiments.

Aquaculture assembly 20.1 includes a pressure relief valve 246 operatively connected to and downstream of minimum pressure valve 92.1. The pressure relief valve is in fluid communication with the minimum pressure valve via conduit 140.1 in this example. Pressure relief valve 246 is interposed between the minimum pressure valve 92.1 and oxygen concentrator 132.1. Prior to first portion 40F′.1 of the compressed air reaching the oxygen concentrator, the pressure relief valve so positioned may ensure that at no point in the oxygen pressure swing adsorption (PSA) cycle does the incoming air have no escape direction. Pressure relief valve 246 is set at approximately 65 psig in one non-limiting example to ensure that only a low rise in pressure occurs before venting; however, this is not strictly required and this pressure setting may be higher or lower in other embodiments.

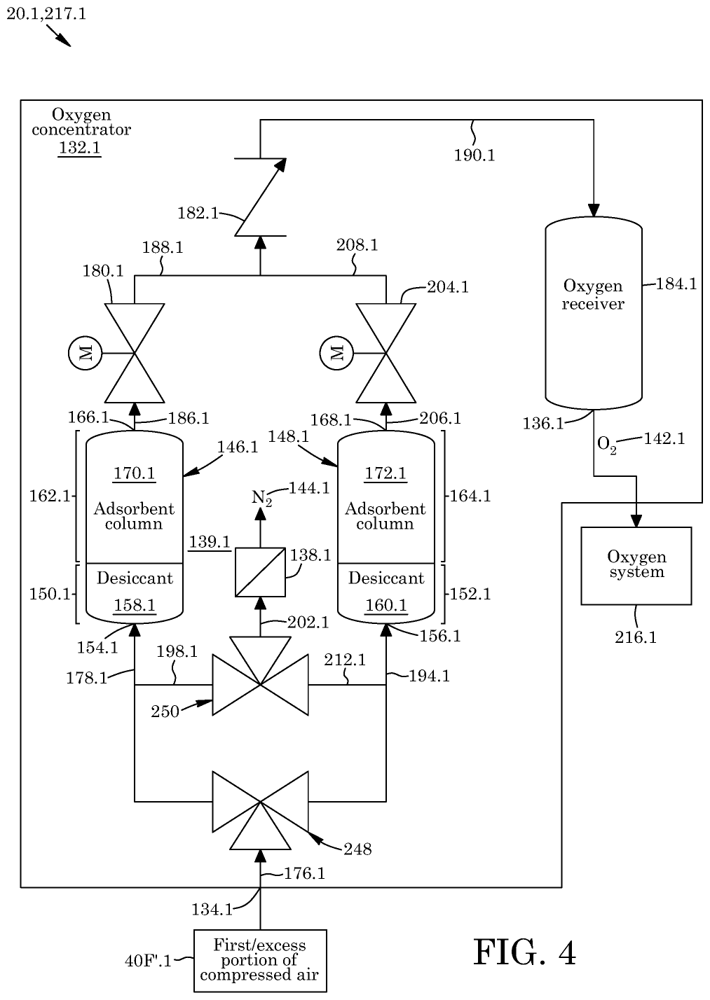

Referring to FIG. 4, oxygen concentrator 132.1 in this example includes a three-way inlet valve 248 instead of control valves 174 and 192 of oxygen concentrator 132 seen in FIG. 2. Referring back to FIG. 4, the three-way inlet valve is configured to enable first portion 40F′.1 of the compressed air and conduit 176.1 to be selectively in fluid communication with conduit 178.1 and adsorbent column or vessel 146.1, or to be selectively in fluid communication with conduit 194.1 and adsorbent column or vessel 148.1. Three-way inlet valve 248 thus determines and/or is adjusted to determine the vessel to which incoming first portion 40F′.1 of the compressed air is to be selectively directed. First portion 40F′.1 of the compressed air may be first passed into first vessel 146.1, where nitrogen is preferentially adsorbed out of the air via adsorbent 170.1, leaving a mostly-oxygen output. Control valve 180.1 in this example atop the first vessel is configured to ensure that the first vessel is charged to an adequate or pre-determined minimum threshold of pressure to ensure that adsorption of the nitrogen occurs, before flow-through of concentrated oxygen 142.1 to oxygen receiver 184.1 via conduit 188.1, check valve 182.1 and conduit 190.1.

The outlet gas composition of vessel 170.1 to oxygen receiver 184.1 may in one non-limiting example comprise 92±2% oxygen gas, 5±2% nitrogen gas, and 3±2% argon gas; however, this is not strictly required and the gas composition may be different in other embodiments. The output gas may be substantially or completely dried by desiccant 158.1 such as adsorbent beads configured to adsorb incoming water vapor, which was lowered to a point where it could be handled by vessel 146.1. The output gas flow is maintained in one non-limiting example at a reduced pressure from the pressure of first portion 40F′.1 of the compressed air at input, with the output gas flow comprising approximately 40 psig; however, this is not strictly required and the pressure may be higher or lower in other embodiments. As mentioned this gas selectively passes through control valve 180.1 and check valve 182.1 towards oxygen receiver 184.1, where the gas is ultimately consumed by oxygen system 216.1.

Oxygen concentrator 132.1 in this example includes a three-way exhaust valve 250 instead of control valves 196 and 210 of oxygen concentrator 132 seen in FIG. 2. Referring back to FIG. 4, the three-way exhaust valve is configured to enable conduits 178.1, 198.1 and 202.1 to be selectively in fluid communication with exhaust outlet 138.1 and atmosphere 139.1 or conduits 194.1, 212.1 and 202.1 be selectively in fluid communication with the exhaust outlet and atmosphere. The non-producing column or second vessel 148.1 is exposed to atmosphere 139.1 via three-way exhaust valve 250 and exhaust outlet 138.1, lowering the pressure in the second vessel and releasing nitrogen gas stored by adsorbent beads. Control valve 204.1 in this example atop non-producing vessel 148.1 may open a small amount after initial exposure to atmosphere to reject the nitrogen gas filling the vessel and replace the nitrogen gas so rejected with expanded oxygen gas from the producing vessel 146.1. The above cycle may be repeated with selective actuation of three-way valves 248 and 250 in a manner similar to that describe for oxygen concentrator 132 and aquaculture assembly 20 seen in FIG. 2 and will accordingly not be described in further detail.

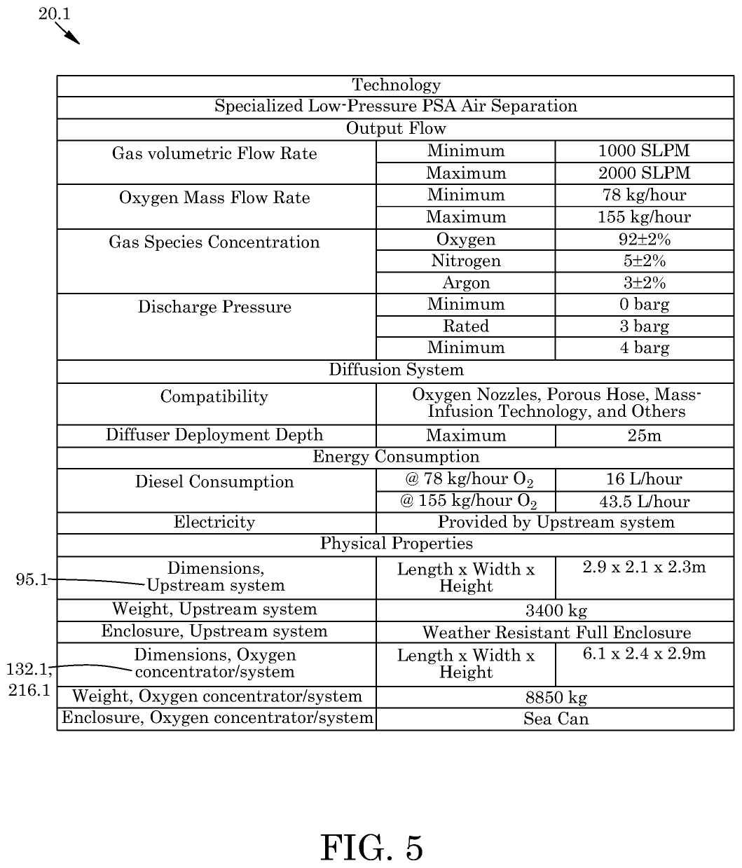

Referring back to FIG. 3, upstream system 95.1 may be configured to supply oxygen concentrator 132.1 with 1000 SCFM of input air to achieve the rated flow in one non-limiting example. Illustrative/sample volumetric flowrates are provided in the table set out in FIG. 5 and may be equal to approximately 2000 SLPM of oxygen flow in this mon-limiting example. Thus, the final output of aquaculture assembly 20.1 in this non-limiting example may be varied between a maximum of 1000 SCFM air and 0 SLPM oxygen, or 0 SCFM air and 2000 SLPM oxygen depending on the requirements of the site.

It will be appreciated that many variations are possible within the scope of the invention described herein. Where a component (e.g. a system, assembly, apparatus, device, software module, processor, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

Examples of aquaculture assemblies, oxygen generation systems for aquaculture and methods of generating concentrated oxygen and compressed air for aquaculture, have been described. The following clauses are offered as further description.
(1) An aquaculture assembly comprising: a compressor configured to output compressed air; and one or more valves actuation of which enables said compressed air to be selectively directed to one or more of an aeration system or an oxygen concentrator.
(2) An aquaculture assembly according to any preceding clause or any clause herein, including a prime mover which powers the compressor.
(3) An aquaculture assembly to any preceding clause or any clause herein, wherein the prime mover directly couples to the compressor.
(4) An aquaculture assembly to any preceding clause or any clause herein, wherein the prime mover is a variable speed engine.
(5) An aquaculture assembly according to any preceding clause or any clause herein, wherein the compressor has a low volume ratio (Vi).
(6) An aquaculture assembly according to any preceding clause or any clause herein, wherein the compressor is an oil-injected said compressor.
(7) An aquaculture assembly according to any preceding clause or any clause herein, including an air-oil separator downstream of the compressor, the air-oil separator being configured to separate oil from the compressed air outputted from the compressor and re-circulate the oil to the compressor.
(8) An aquaculture assembly according to any preceding clause or any clause herein, including a fluid-air heat exchanger downstream of the compressor.
(9) An aquaculture assembly according to clause 7 or any clause herein, including a fluid-air heat exchanger downstream of the air-oil separator.
(10) An aquaculture assembly according to any one of clauses 8 to 9 or any clause herein, wherein the fluid-air heat exchanger is configured to cool the compressed air outputted from the compressor and passing therethrough.
(11) An aquaculture assembly according to any one of clauses 8 to 10 or any clause herein, including a pump configured to direct cooling water through the fluid-air heat exchanger, with the compressed air being cooled thereby.
(12) An aquaculture assembly according to any preceding clause or any clause herein, wherein the fluid-air heat exchanger is a liquid-air heat exchanger.
(13) An aquaculture assembly according to any preceding clause or any clause herein, wherein the fluid-air heat exchanger is a water-air heat exchanger.
(14) An aquaculture assembly according to any preceding clause or any clause herein, wherein water is condensed out of the compressed air.
(15) An aquaculture assembly according to any preceding clause or any clause herein, wherein oil vapor is removed from the compressed air.
(16) An aquaculture assembly according to any preceding clause or any clause herein, including an alternator powered by the prime mover, the alternator being configured to provide electrical energy to the assembly or components thereof.
(17) An aquaculture assembly according to any preceding clause or any clause herein, wherein the alternator provides electrical energy to both the aeration system and the oxygenation system.
(18) An aquaculture assembly according to any one of clauses 8 to 13 or any clause herein, including a filtration unit downstream of the fluid-air heat exchanger.
(19) An aquaculture assembly to clause 18 or any clause herein, wherein the filtration unit is effective to a predetermined threshold or oil carry over rate.
(20) An aquaculture assembly according to any one of clauses 18 to 19 or any clause herein, wherein the filtration unit is a static said filtration unit.
(21) An aquaculture assembly according to any one of clauses 18 to 20 or any clause herein, wherein the filtration unit comprises a cyclonic separator for bulk water and one or more coalescing filters for oil removal.
(22) An aquaculture assembly according to any preceding clause or any clause herein, wherein a first said valve connectable to the oxygen concentrator, the first said valve comprising at least in part a check valve to inhibit a backflow of said compressed air into an air end of the compressor.
(23) An aquaculture assembly according to any clause 22 or any clause herein, wherein the first said valve is configured to retain a minimum pressure in the compressor to promote lubrication and functioning of the compressor.
(24) An aquaculture assembly according to any one of clauses 1 to 23 or any clause herein, including a first said valve connectable to the oxygen concentrator, the first said valve comprising a minimum pressure valve.
(25) An aquaculture assembly according to any one of clauses 1 to 24 or any clause herein, including a second said valve connectable to the aeration system, the second said valve being configured to incrementally open to increase downstream pressure, and the second said valve being configured to incrementally close to decrease downstream pressure.
(26) An aquaculture assembly according to any one of clauses 1 to 24 or any clause herein, including a second said valve connectable to the aeration system, the second said valve comprising a forward pressure regulator.
(27) An aquaculture assembly according to any preceding clause or any clause herein, including said oxygen concentrator.
(28) An aquaculture assembly according to any preceding clause or any clause herein, wherein said oxygen concentrator is configured to produce gas of enriched oxygen.
(29) An aquaculture assembly according to any preceding clause or any clause herein, wherein said oxygen concentrator is configured to produce gas comprising an elevated concentration of oxygen compared to the concentration of oxygen in air.
(30) An aquaculture assembly according to any preceding clause or any clause herein, wherein said oxygen concentrator is configured to receive an input gas in the form of said compressed air or a portion thereof so directed thereto and wherein said oxygen concentrator is configured produce an output gas comprising gaseous oxygen in a higher concentration compared to that of the input gas.
(31) An aquaculture assembly according to any preceding clause or any clause herein, wherein said oxygen concentrator is configured to receive an input gas in the form of said compressed air or a portion thereof so directed thereto and wherein said oxygen concentrator is configured produce an output gas comprising dioxygen in a higher concentration compared to that of the input gas.
(32) An aquaculture assembly according to any preceding clause or any clause herein, wherein the oxygen concentrator comprises pressure swing adsorption (PSA) or is a pressure swing adsorption (PSA) said oxygen concentrator.
(33) An aquaculture assembly according to any preceding clause or any clause herein, wherein the oxygen concentrator including one or more vessels via which the compressed air is selectively received, with each said vessel including an adsorbent and a desiccant therewithin.
(34) An aquaculture assembly according to clause 33 or any clause herein, wherein the desiccant is positioned to dehumidify the compressed air prior to being directed towards the adsorbent.
(35) An aquaculture assembly according to any clause herein, wherein: the desiccant is positioned to dehumidify the compressed air prior to being directed towards the adsorbent; wherein the fluid-air heat exchanger is configured to condense out water; and/or wherein the fluid-air heat exchanger is configured to condense out oil vapor from the compressed air.
(36) An aquaculture assembly according to any one of clauses 33 to 35 or any clause herein, wherein the desiccant is configured to receive a lower input humidity load.
(37) An aquaculture assembly according to any preceding clause or any clause herein, including said aeration system.
(38) An aquaculture assembly comprising: a variable speed engine; and a compressor directly coupled to and powered by the engine, the compressor being configured to output compressed air via an outlet thereof.
(39) An aquaculture assembly according to clause 38 or any subsequent or preceding clause, including one or more valves downstream of the compressor and actuation of which enables said compressed air to be selectively directed to one or more of an aeration system or an oxygen concentrator.
(40) An aquaculture assembly comprising: an aeration system; an oxygen concentrator; and a compressor operatively connected to both the aeration system and the oxygen concentrator, with the aquaculture assembly being configured to selectively direct compressed air from the compressor to either the aeration system and the oxygen concentrator or both thereof.
(41) An aquaculture assembly according to clause 40 or any clause herein, including a prime mover which powers the compressor.
(42) An aquaculture assembly according to clause 41 or any clause herein, wherein the primer mover is a variable speed engine.
(43) An aquaculture assembly according to any one of clauses 41 to 42 or any clause herein, wherein selective adjustment of the speed of said prime mover or said engine enables on-the-fly adjustment of one or more of the aeration system or the oxygen concentrator.
(44) An aquaculture assembly according to any one of clauses 41 to 43 or any clause herein, wherein selective adjustment of the speed of said prime mover or said engine enables on demand adjustment of one or more of the aeration system or the oxygen concentrator.
(45) An aquaculture assembly according to any one of clauses 41 to 44 or any clause herein, wherein selective adjustment of the speed of said prime mover or said engine enables real-time adjustment of one or more of the aeration system or the oxygen concentrator.
(46) An aquaculture assembly according to any one of clauses 41 to 45 or any clause herein, wherein selective adjustment of the speed of the engine enables on-the-fly adjustment of the split between aeration and oxygen production while inhibiting losses due to compressor throttling or start-stop operation.
(47) An aquaculture assembly according to any one of clauses 41 to 46 or any clause herein, wherein selective adjustment of the speed of the engine enables on demand adjustment of the split between aeration and oxygen production while inhibiting losses due to compressor throttling or start-stop operation.
(48) An aquaculture assembly according to any one of clauses 41 to 47 or any clause herein, wherein selective adjustment of the speed of the engine enables real-time adjustment of the split between aeration and oxygen production while inhibiting losses due to compressor throttling or start-stop operation.
(49) An aquaculture assembly according to any one of clauses 40 to 48 or any clause herein, including air treatment components common to both the aeration system and the oxygen concentrator.
(50) An aquaculture assembly according to any one of clauses 40 to 48 or any clause herein, including a heat exchanger and/or a filtration unit operatively connected to and downstream of the compressor, with the heat exchanger and/or the filtration unit being common to both the aeration system and the oxygen concentrator.
(51) An aquaculture assembly according to any one of clauses 40 to 50 or any clause herein, wherein the aeration system has an outlet and wherein the oxygen concentrator has an outlet different than and/or distinct from the outlet of the aeration system.
(52) An aquaculture assembly according to any one of clauses 1 to 51 or any clause herein, wherein the compressor is a screw compressor.
(53) An aquaculture assembly according to any one of clauses 1 to 52 or any clause herein, wherein the aeration system and the oxygen concentrator operatively connect to and use a common or shared said compressor.
(54) An aquaculture assembly according to any one of clauses 1 to 53 or any clause herein, wherein a single said compressor is used for both the aeration system and the oxygen concentrator.
(55) An aquaculture assembly comprising: an aeration system having an outlet and being configured to receive compressed air from a single source; and an oxygen concentrator having an outlet and being configured to selectively receive compressed air from said single source, with the outlet of the oxygen concentrator being different than and/or distinct from the outlet of the aeration system.
(56) An aquaculture assembly according to clause 55 or any clause herein, wherein said single source comprises a compressor.
(57) An aquaculture assembly or unified system that provides a means to co-generate compressed air and concentrated oxygen continuously and on-demand modify a split ratio between the compressed air and the concentrated oxygen.
(58) An aquaculture assembly comprising: a compressor configured to generate compressed air; an aeration system to which a set portion of the compressed air is directed; and an oxygen concentrator to which an excess portion of the compressed air is diverted, the oxygen concentrator being configured to generate concentrated oxygen from the excess portion of the compressed air.
(59) An aquaculture assembly comprising: a compressor configured to generate compressed air, with a set portion of the compressed air being directed to an aeration system and an excess portion of the compressed air being directed to an oxygen concentrator, and with concentrated oxygen being generated from the compressed air diverted to the oxygen concentrator.
(60) An aquaculture assembly according to any one of clauses 55 to 56 or any clause herein, including a flow-directing member which enables the set portion of the compressed air being directed to the aeration system so as to be anywhere in the range of between 0-100% of the compressed air outputted from the compressor.
(61) An aquaculture assembly according to any one of clauses 55 to 57 or any clause herein, wherein the flow-directing member enables the excess portion of the compressed air directed to the oxygen concentrator to be adjusted so as to be anywhere in the range of between 0-100% of the compressed air outputted from the compressor.
(62) An aquaculture assembly according to any one of clauses 55 to 56 or any clause herein, including a flow-directing member which enables the set portion of the compressed air being directed to the aeration system to be adjusted as to be anywhere in the range of between 0-100% of the compressed air outputted from the compressor and/or which enables the excess portion of the compressed air being directed to the oxygen concentrator to be adjusted so as to be anywhere in the range of between 0-100% of the compressed air outputted from the compressor.
(63) An aquaculture assembly according to any one of clauses 55 to 56 or any clause herein, including a three-way valve which enables the set portion of the compressed air being directed to the aeration system to be adjusted as to be anywhere in the range of between 0-100% of the compressed air outputted from the compressor and/or which enables the excess portion of the compressed air being directed to the oxygen concentrator to be adjusted so as to be anywhere in the range of between 0-100% of the compressed air outputted from the compressor.
(64) An aquaculture assembly according to any one of clauses 55 to 60 or any clause herein, wherein the aquaculture assembly is configured to enable the set portion of the compressed air being directed to the aeration system and/or the excess portion of the compressed air being directed to the oxygen concentrator, to be adjusted in real-time.
(65) An aquaculture assembly according to any one of clauses 55 to 64 or any clause herein, wherein the aquaculture assembly is configured to enable the set portion of the compressed air being directed to the aeration system and/or the excess portion of the compressed air being directed to the oxygen concentrator, to be adjusted on demand.
(66) An aquaculture assembly according to any one of clauses 55 to 65 or any clause herein, wherein the aquaculture assembly is configured to enable the set portion of the compressed air being directed to the aeration system and/or the excess portion of the compressed air being directed to the oxygen concentrator, to be adjusted on-the-fly.
(67) An aquaculture assembly according to any one of clauses 55 to 66 or any clause herein, wherein the aquaculture assembly is configured to direct said compressed air to the aeration system, to the oxygen system and/or to both the aeration system and the oxygen system.
(68) An aquaculture assembly according to any one of clauses 55 to 67 or any clause herein, wherein the compressor is engine-driven.
(69) An aquaculture assembly according to any one of clauses 55 to 68 or any clause herein, wherein the compressor has a low-volume ratio.
(70) An aquaculture assembly according to any one of clauses 55 to 68 or any clause herein, wherein the compressor is an oil-injected said compressor.
(71) An aquaculture assembly comprising: an aeration system configured to receive compressed air; and a minimum pressure valve operatively connected to the aeration system, wherein the minimum pressure valve is configured to actuate in response to an excess portion of compressed air not being consumed by the aeration system, with the minimum pressure valve so actuated being configured to direct said excess portion of compressed air to an oxygen concentrator.
(72) An aquaculture assembly comprising: an aeration system configured to receive compressed air; and a minimum pressure valve operatively connected to the aeration system, wherein the minimum pressure valve is configured to actuate upon being subjected to a pressure equal to or greater than a predetermined threshold of pressure indicative an excess portion of compressed air not being consumed by the aeration system, with the minimum pressure valve so actuated being configured to direct said excess portion of compressed air to an oxygen concentrator.
(73) An aquaculture assembly according to any one of clauses 71 to 72 or any clause herein, including said oxygen concentrator.
(74) An aquaculture assembly according to any one of clauses 1 to 73 or any clause herein, wherein the oxygen concentrator produces gaseous oxygen at a pressure which is equal to or less than 80 psig.
(75) An aquaculture assembly according to any one of clauses 1 to 74 or any clause herein, wherein the oxygen concentrator produces gaseous oxygen at a pressure in the range of equal to or greater than 45 psig and less than 80 psig.
(76) An aquaculture assembly according to any one of clauses 1 to 74 or any clause herein, wherein the oxygen concentrator produces gaseous oxygen at a pressure in the range of equal to or greater than 45 psig and equal to or less than 65 psig.
(77) An aquaculture assembly according to any one of clauses 1 to 74 or any clause herein, wherein the oxygen concentrator produces gaseous oxygen at a pressure in the range of equal to or greater than 40 psig and equal to or less than 45 psig.
(78) An aquaculture assembly according to any one of clauses 1 to 77 or any clause herein, wherein the compressor produces compressed air at a pressure which is equal to or less than 125 psig.
(79) An aquaculture assembly according to any one of clauses 1 to 77 or any clause herein, wherein the compressor produces compressed air at a pressure in the range of equal to or greater than 45 psig and less than 125 psig.
(80) An aquaculture assembly according to any one of clauses 1 to 77 or any clause herein, wherein the compressor compresses air to approximately 45 psig.
(81) An aquaculture assembly according to any one of clauses 1 to 80 or any clause herein, wherein the compressor produces compressed air at a pressure which is equal within a predetermined threshold to the pressure at which gaseous oxygen is outputted from the oxygen concentrator.
(82) An aquaculture assembly according to any one of clauses 1 to 80 or any clause herein, wherein the pressure of the compressed air produced by the compressor is equal to the pressure at which gaseous oxygen is outputted from the oxygen concentrator within a predetermined threshold of ±10 psig.
(83) An aquaculture assembly according to any one of clauses 1 to 80 or any clause herein, wherein the pressure of the compressed air produced by the compressor is equal to the pressure at which gaseous oxygen is outputted from the oxygen concentrator within a predetermined threshold of ±5 psig.
(84) An aquaculture assembly according to any preceding or any clause herein, wherein the aquaculture assembly is configured to selectively direct compressed air via the aeration system to an aquaculture enclosure.
(85) An aquaculture assembly according to any preceding or any clause herein, wherein the aquaculture assembly is configured to selectively direct oxygen enriched gas via the oxygen concentrator to the aquaculture enclosure.
(86) An aquaculture assembly according to any one of clauses 1 to 83 or any clause herein, wherein the aquaculture assembly is configured to selectively direct compressed air via a conduit of the aeration system to an aquaculture enclosure and wherein the aquaculture assembly is configured to selectively direct oxygen enriched gas to the aquaculture enclosure via a conduit of the oxygen concentrator and/or a conduit of an oxygen system operatively connected to the oxygen concentrator, with the conduit of the aeration system being different than and/or distinctive from the conduit of the oxygen concentrator and/or the conduit of the oxygen system.
(87) An aquaculture assembly according to any one of clauses 1 to 83 or any clause herein, wherein the aquaculture assembly is configured to selectively direct compressed air via an outlet of the aeration system to an aquaculture enclosure and wherein the aquaculture assembly is configured to selectively direct oxygen enriched gas via an outlet of the oxygen concentrator to the aquaculture enclosure, with the outlet of the aeration system being different than and/or distinctive from the outlet of the oxygen concentrator.
(88) An aquaculture assembly according to any preceding or any clause herein, including said aquaculture enclosure.
(89) An aquaculture assembly according to any preceding or any clause herein, including a processor operatively connected to and configured to selectively adjust the variable speed engine.
(90) An aquaculture assembly according to any preceding or any clause herein, including a processor operatively connected to and configured to selectively adjust one or more of the compressor, the aeration system, or the oxygen concentrator.
(91) An aquaculture assembly according to any preceding or any clause herein, including a processor operatively connected to and configured to selectively adjust one or more of the compressor and the extent to which compressed air is directed to the aeration system, the oxygen concentrator or both.
(92) An aquaculture assembly comprising: a compressor; an aeration system operatively connected to the compressor so as to selectively receive compressed air therefrom; and an oxygen concentrator operatively connected to the compressor so as to selectively receive compressed air therefrom, with the outlet of the oxygen concentrator being different than and/or distinct from the outlet of the aeration system.
(93) An aquaculture assembly comprising: a compressor; an aeration system operatively connected to the compressor so as to selectively receive compressed air therefrom; an oxygen concentrator operatively connected to the compressor so as to selectively receive compressed air therefrom; and air treatment components common to both the aeration system and the oxygen concentrator.
(94) An aquaculture assembly comprising: a compressor; and a plurality of valves downstream of the compressor, with actuation of one or more of the plurality of valves enabling compressed air from the compressor to be selectively directed to one or both of an aeration system and an oxygen concentrator, with the plurality of valves including a first said valve connectable to the oxygen concentrator, the first said valve comprising a minimum pressure valve and comprising at least in part a check valve to inhibit a backflow of said compressed air into an air end of the compressor, and with the plurality of valves including a second said valve connectable to the aeration system, the second said valve comprising a forward pressure regulator which, when incrementally opened, increases downstream pressure and which, when incrementally closed, decreases downstream pressure.
(95) An oxygen generation system for aquaculture, the system comprising: a fluid-air heat exchanger configured to receive therethrough and cool compressed air; a filtration unit downstream of the fluid-air exchanger and configured to remove liquid from the compressed air so cooled; and an oxygen concentrator downstream of the filtration unit, the oxygen concentrator including one or more vessels via which the compressed air is selectively received, each said vessel including an adsorbent and a desiccant therewithin.
(96) An oxygen generation system for aquaculture, the system comprising: a fluid-air heat exchanger configured to receive therethrough and one or more of cool compressed air and condense out water and/or oil vapor thereby; a filtration unit downstream of the fluid-air exchanger and configured to remove liquid from the compressed air so cooled; a desiccant downstream of the filtration unit; and an oxygen concentrator downstream of the filtration unit, the oxygen concentrator being configured to receive the compressed air so dehumidified and output concentrated oxygen.
(97) A method of generating concentrated oxygen and compressed air for aquaculture, the method comprising: directly coupling a prime mover to a compressor so as to output compressed air; selectively directing a first portion of the compressed air to an oxygen concentrator; and selectively directing a second portion of the compressed air to an aeration system.
(98) A method according to clause 94 or any clause herein, wherein the prime mover is a variable speed engine.
(99) A method according to any one of clauses 94 to 95 or any clause herein, including positioning one or more valves between an outlet of the compressor and an inlet of the oxygen concentrator and between the outlet of the compressor and an inlet of the aeration system, respectively.
(100) A method according to any one of clauses 94 to 95 or any clause herein, including positioning a first valve between an outlet of the compressor and an inlet of the oxygen concentrator and positioning a second valve between the outlet of the compressor and an inlet of the aeration system.
(101) A method according to any one of clauses 96 to 97 or any clause herein, adjusting the split between aeration and oxygen production at least in part by selectively adjusting the one or more said valves.
(102) A method according to any one of clauses 94 to 98 or any clause herein, including positioning a minimum pressure valve between the outlet of the compressor and the inlet of the oxygen concentrator.
(103) A method according to any one of clauses 94 to 99 or any clause herein, including positioning a forward pressure regulator between the outlet of the compressor and the inlet of the aeration system.
(104) A method according to any one of clauses 94 to 100 or any clause herein, including adjusting the split between aeration and oxygen production on-the-fly.
(105) A method according to any one of clauses 94 to 101 or any clause herein, including adjusting the split between aeration and oxygen production on demand.
(106) A method according to any one of clauses 94 to 102 or any clause herein, including adjusting the split between aeration and oxygen production in real-time.
(107) A method according to clause 95 or any clause herein, including adjusting the split between aeration and oxygen production at least in part by adjusting the speed of the engine.
(108) A method according to any one of clauses 94 to 104 or any clause herein, including lowering an oxygen production pressure of the oxygen concentrator to be closer in value to an air system operating pressure of the aeration system.
(109) A method according to any one of clauses 94 to 105 or any clause herein, including adjusting the oxygen production pressure of the oxygen concentrator to be equal within a predetermined threshold, to the air system operating pressure of the aeration system.
(110) A method according to any one of clauses 94 to 106 or any clause herein, including removing humidity from the compressed air via a fluid-air heat exchanger.
(111) A method according to any one of clauses 94 to 107 or any clause herein, including removing humidity from the compressed air via a filtration unit.
(112) A method according to any one of clauses 94 to 108 or any clause herein, including removing fluid from the compressed air via a cyclonic separator.
(113) A method according to any one of clauses 94 to 109 or any clause herein, including removing fluid from the compressed air via one or more coalescing filters.
(114) A method according to any one of clauses 94 to 110 or any clause herein, including removing humidity via a desiccant within one or more vessels of the oxygen concentrator.
(115) A method of generating compressed air for aquaculture assembly, the method comprising: providing motive power via a variable speed engine; and powering a compressor via the variable speed engine; and outputting compressed air via the compressor.
(116) A method of generating oxygen for aquaculture, the method comprising: directing compressed air through a liquid-air heat exchanger so as to cool the compressed air; directing the compressed air so cooled through a filtration unit to remove liquid therefrom; and outputting oxygen via an oxygen concentrator downstream of the filtration unit.
(117) A method according to clause 113 or any clause herein, including dehumidifying the compressed air via a desiccant positioned downstream of the filtration unit.
(118) A method according to clause 114 or any clause herein, including positioning the desiccant within one or more vessels of the oxygen concentrator.
(119) A method according to any one of clauses 113 to 115 or any clause herein, including selectively adsorbing nitrogen within the oxygen concentrator via an adsorbent downstream of the desiccant.
(120) A method of generating concentrated oxygen and compressed air for aquaculture, the method comprising: providing a compressor configured to output compressed air; providing one or more valves downstream of the compressor; and operatively connecting an aeration system and an oxygen concentrator to the compressor via said one or more valves.
(121) A method according to clause 117 or any clause herein, including: configuring the one or more valves such that actuation thereof enables said compressed air to be selectively directed to the aeration system, the oxygen concentrator or both the aeration system and the oxygen concentrator.
(122) A method of generating concentrated oxygen and compressed air for aquaculture, the method comprising: providing an aeration system and an oxygen concentrator; and operatively connecting together the aeration system and the oxygen concentrator via a single compressor upstream thereof.
(123) A method according to clause 119 or any clause herein, including: configuring the single compressor to provide compressed air to the aeration system, the oxygen concentrator or both the aeration system and the oxygen concentrator.
(124) A method of generating concentrated oxygen and compressed air for aquaculture, the method comprising: providing a compressor configured to generate compressed air; directing a set portion of the compressed air to an aeration system; and diverting an excess portion of the compressed air to an oxygen concentrator.
(125) A method according to clause 121 or any clause herein, including: diverting the excess portion of the compressed air to the oxygen concentrator based on the compressed air reaching a pressure that equals to or exceeds a predetermined threshold of pressure.
(126) A method according to any one of clauses 121 to 122 or any clause herein, including adjusting in real-time the set portion of the compressed air being directed to the aeration system and/or the excess portion of the compressed air being directed to the oxygen concentrator.
(127) A method according to any one of clauses 121 to 123 or any clause herein, including adjusting on demand the set portion of the compressed air being directed to the aeration system and/or the excess portion of the compressed air being directed to the oxygen concentrator.
(128) A method according to any one of clauses 121 to 124 or any clause herein, including adjusting the set portion of the compressed air being directed to the aeration system; and/or the excess portion of the compressed air being directed to the oxygen concentrator on-the-fly.
(129) A method of generating concentrated oxygen and compressed air for aquaculture, the method comprising: arranging an aeration system to receive compressed air from a single source; configuring an oxygen concentrator to selectively receive compressed air from the single source; arranging the outlet of the oxygen concentrator to be different than and/or distinct from the outlet of the aeration system.
(130) A method of generating concentrated oxygen and compressed air for aquaculture, the method comprising: configuring an aeration system to receive compressed air; operatively connecting a minimum pressure valve to the aeration system; configuring the minimum pressure valve to actuate in response to an excess portion of compressed air not being consumed by the aeration system; and directing said excess portion of compressed air to an oxygen concentrator in response to the minimum pressure valve so actuated.
(131) A method according to clause 127 or any clause herein, including within the configuring step, configuring the minimum pressure valve to actuate upon being subjected to a pressure equal to or greater than a predetermined threshold of pressure indicative of the excess portion of compressed air not being consumed by the aeration system.
(132) A method according to any one of clauses 127 to 128 or any clause herein, including within the directing step, directing said excess portion of compressed air to the oxygen concentrator via the minimum pressure valve.
(133) A method according to any one of clauses 94 to 129 or any herein, wherein the oxygen concentrator comprises pressure swing adsorption (PSA) or is a pressure swing adsorption (PSA) said oxygen concentrator.
(134) A method according to any one of clauses 94 to 130 or any clause herein, including configuring the oxygen concentrator to produce gaseous oxygen at a pressure which is equal to or less than 80 psig.
(135) A method according to any one of clauses 94 to 130 or any clause herein, including configuring the oxygen concentrator to produce gaseous oxygen at a pressure in the range of equal to or greater than 45 psig and less than 80 psig.
(136) A method according to any one of clauses 94 to 130 or any clause, including configuring the oxygen concentrator to produce gaseous oxygen at a pressure in the range of equal to or greater than 45 psig and equal to or less than 65 psig.
(137) A method according to any one of clauses 94 to 130 or any clause herein, including configuring the oxygen concentrator to produce gaseous oxygen at a pressure in the range of equal to or greater than 40 psig and equal to or less than 45 psig.
(138) A method according to any one of clauses 94 to 112 and 117 to 125 or any clause herein, including configuring the compressor to produce compressed air at a pressure which is equal to or less than 125 psig.
(139) A method according to any one of clauses 94 to 112 and 117 to 125 or any clause herein, including configuring the compressor to produce compressed air at a pressure in the range of equal to or greater than 45 psig and less than 125 psig.
(140) A method according to any one of clauses 94 to 112 and 117 to 125 or any clause herein, including configuring the compressor to compress air to approximately 45 psig.
(141) A method according to any one of clauses 94 to 112 and 117 to 125 or any clause herein, including configuring the compressor to produce compressed air at a pressure which is equal within a predetermined threshold to the pressure at which gaseous oxygen is outputted from the oxygen concentrator.
(142) A method according to any one of clauses 94 to 112 and 117 to 125 or any clause herein, including adjusting the pressure of the compressed air produced by the compressor so as to equal to the pressure at which gaseous oxygen is outputted from the oxygen concentrator within a predetermined threshold of ±10 psig.
(143) A method according to any one of clauses 94 to 112 and 117 to 125 or any clause herein, including adjusting the pressure of the compressed air produced by the compressor so to as equal to the pressure at which gaseous oxygen is outputted from the oxygen concentrator within a predetermined threshold of ±5 psig.
(144) A method according to any clause herein, including directing compressed air via the aeration system to an aquaculture enclosure.
(145) A method according to any clause herein, including selectively directing oxygen enriched gas via the oxygen concentrator to the aquaculture enclosure.
(146) A method according to any clause herein, including: directing compressed air via a conduit of the aeration system to an aquaculture enclosure; and selectively directing oxygen enriched gas to the aquaculture enclosure via a conduit of the oxygen concentrator and/or a conduit of an oxygen system operatively connected to the oxygen concentrator, with the conduit of the aeration system being different than and/or distinctive from the conduit of the oxygen concentrator and/or the conduit of the oxygen system.
(147) A method according to any one of clauses 122 to 125 or any clause herein, including enabling the set portion of the compressed air being directed to the aeration system to be adjusted via a flow-directing member so as to be anywhere in the range of between 0-100% of the compressed air outputted from the compressor.
(148) A method according to any one of clauses 122 to 125 and 144 or any clause herein, including enabling the excess portion of the compressed air being directed to the oxygen concentrator to be adjusted via the flow-directing member so as to be anywhere in the range of between 0-100% of the compressed air outputted from the compressor.
(149) A method according to any one of clauses 94 to 95 or any clause herein, including: selectively adjusting of the speed of said prime mover or said engine to enable on-the-fly adjustment of one or more of the aeration system or the oxygen concentrator.
(150) A method according to any one of clauses 94 to 95 or any clause herein, wherein selective adjustment of the speed of the engine enables on-the-fly adjustment of the split between aeration and oxygen production while inhibiting losses due to compressor throttling or start-stop operation.
(151) A method according to any one of clauses 94 to 95 and 146 to 147 or any clause herein, including: selectively adjusting of the speed of said prime mover or said engine to enable on demand adjustment of one or more of the aeration system or the oxygen concentrator.
(152) A method according to any one of clauses 94 to 95 and 146 to 147 or any clause herein, wherein selective adjustment of the speed of the engine enables on demand adjustment of the split between aeration and oxygen production while inhibiting losses due to compressor throttling or start-stop operation.
(153) A method according to any one of clauses 94 to 95 and 146 to 149 or any clause herein, including: selectively adjusting of the speed of said prime mover or said engine to enable real-time adjustment of one or more of the aeration system or the oxygen concentrator.
(154) A method according to any one of clauses 94 to 95 and 146 to 149 or any clause herein, wherein selective adjustment of the speed of the engine enables real-time adjustment of the split between aeration and oxygen production while inhibiting losses due to compressor throttling or start-stop operation.
(155) A method according to any clause herein, including arranging air treatment components common to and upstream of both the aeration system and the oxygen concentrator.
(156) Apparatus including any new and inventive feature, combination of features, or sub-combination of features as described herein.
(157) Methods including any new and inventive steps, acts, combination of steps and/or acts or sub-combination of steps and/or acts as described herein.

What is claimed is:

1. An aquaculture assembly comprising:
a compressor;
an aeration system operatively connected to the compressor so as to selectively receive compressed air therefrom; and
an oxygen concentrator operatively connected to the compressor so as to selectively receive compressed air therefrom, with the outlet of the oxygen concentrator being different than and/or distinct from the outlet of the aeration system.

2. An aquaculture assembly according to claim 1, including a valve via which the compressed air from the compressor is directed to either the aeration system and the oxygen concentrator or both thereof.

3. An aquaculture assembly according to claim 1, wherein the aquaculture assembly is configured to selectively direct compressed air from the compressor to either the aeration system and the oxygen concentrator or both thereof.

4. An aquaculture assembly according to claim 1, wherein the aeration system includes a conduit via which an aquaculture enclosure selectively receives the compressed air therefrom and wherein the assembly includes a conduit downstream of the oxygen concentrator and via which the aquaculture enclosure selectively receives oxygen enriched gas therefrom, with the conduit of the aeration system being different than and/or distinctive from the conduit downstream of the oxygen concentrator.

5. An aquaculture assembly according to claim 4, including the aquaculture enclosure.

6. An aquaculture assembly according to claim 1, including a prime mover which powers and directly couples to the compressor.

7. An aquaculture assembly according to claim 6, wherein the prime mover is a variable speed engine.

8. An aquaculture assembly according to claim 6, wherein selective adjustment of the speed of said prime mover enables on-the-fly, on demand and/or real-time adjustment of either or both of the aeration system and the oxygen concentrator.

9. An aquaculture assembly according to claim 6, including an alternator powered by the prime mover to provide electrical energy to both the aeration system and the oxygenation concentrator.

10. An aquaculture assembly according to claim 1, wherein the compressed air is generated on-site via a diesel-powered compressor and/or a diesel engine, wherein the compressor has a low volume ratio (Vi), wherein the compressor is an oil-injected compressor and/or wherein the compressor is a screw compressor.

11. An aquaculture assembly according to claim 1, wherein the oxygen concentrator comprises pressure swing adsorption (PSA) or is a pressure swing adsorption (PSA) said oxygen concentrator, wherein the oxygen concentrator includes one or more vessels via which the compressed air is selectively received, and wherein each said vessel includes an adsorbent and a desiccant therewithin, with the desiccant thereof being positioned to dehumidify the compressed air prior to being directed towards the adsorbent thereof.

12. An aquaculture assembly according to claim 1, wherein the oxygen concentrator produces gaseous oxygen at a pressure in the range of equal to or greater than 45 psig and less than 80 psig.

13. An aquaculture assembly according to claim 1, wherein the pressure of the compressed air produced by the compressor is equal to the pressure at which gaseous oxygen is outputted from the oxygen concentrator with a predetermined threshold of ±5 psig.

14. An aquaculture assembly comprising:
a compressor;
an aeration system operatively connected to the compressor so as to selectively receive compressed air therefrom;
an oxygen concentrator operatively connected to the compressor so as to selectively receive compressed air therefrom; and
air treatment components common to both the aeration system and the oxygen concentrator.

15. An aquaculture assembly according to claim 14, wherein the air treatment components are downstream of the compressor, and wherein the air treatment components are upstream of the aeration system and the oxygen concentrator.

16. An aquaculture assembly according to claim 14, wherein the air treatment components comprise a heat exchanger and a filtration unit via which the compressed air outputted from the compressor is treatable.

17. An aquaculture assembly comprising:
a compressor; and
a plurality of valves downstream of the compressor, with actuation of one or more of the plurality of valves enabling compressed air from the compressor to be selectively directed to one or both of an aeration system and an oxygen concentrator, with the plurality of valves including a first said valve connectable to the oxygen concentrator, the first said valve comprising a minimum pressure valve and comprising at least in part a check valve to inhibit a backflow of said compressed air into an air end of the compressor, and with the plurality of valves including a second said valve connectable to the aeration system, the second said valve comprising a forward pressure regulator which, when incrementally opened, increases downstream pressure and which, when incrementally closed, decreases downstream pressure.

18. An aquaculture assembly according to claim 17, including the aeration system and the oxygen concentrator.

19. A method of generating concentrated oxygen and compressed air for aquaculture via the aquaculture assembly of claim 1, the method comprising:
directly coupling a prime mover to a compressor so as to output compressed air;
directing via a flow-directing member, first and second portions of the compressed air to an oxygen concentrator and an aeration system, respectively.

20. A method according to claim 19, including: selectively adjusting of the speed of said prime mover to enable on-the-fly and/or on-demand adjustment of the aeration system and the oxygen concentrator, with selective adjustment of the speed of the prime mover enabling on-the-fly and/or on-demand adjustment of the split between acration and oxygen production while inhibiting losses due to compressor throttling or start-stop operation.
